(19) United States
(12) Patent Application Publication
(10) Pub. No.: US 2026/0101333 A1
(43) Pub. Date: Apr. 9, 2026

(54) CODEBOOK DESIGN FOR 8TX UE WITH TWO COHERENT ANTENNA GROUPS

(71) Applicant: Lenovo (Beijing) Limited, Beijing (CN)

(72) Inventors: Chenxi Zhu, Fairfax, VA (US); Bingchao Liu, Beijing (CN); Yi Zhang, Beijing (CN); Wei Ling, Beijing (CN); Lingling Xiao, Beijing (CN)

(73) Assignee: Lenovo (Beijing) Limited, Beijing (CN)

(21) Appl. No.: 19/112,807

(22) PCT Filed: Feb. 16, 2023
(86) PCT No.: PCT/CN2023/076390

§ 371 Date: Mar. 18, 2025

(51) Int. Cl. H04W 72/1268; H04B 7/06; H04W 72/20; H04W 72/566; H04W 76/20

(52) U.S. Cl. CPC H04W 72/1268; H04B 7/0639; H04W 72/20; H04W 72/566; H04W 76/20

(57) ABSTRACT

Methods and apparatuses for 8TX UE with two coherent antenna groups are disclosed. In one embodiment, a UE comprises a transceiver; and a processor coupled to the transceiver, wherein the processor is configured to receive, via the transceiver, a control message scheduling a PUSCH transmission with transmission rank N to be transmitted by two antenna groups, wherein, the control message includes a TPMI that indicates two 4TX precoding matrices used by the two antenna groups, and the two 4TX precoding matrices are of the same type, wherein, N is any of 2 to 8; and transmit, via the transceiver, the scheduled PUSCH transmission according to the control message.

### FIELD

The subject matter disclosed herein generally relates to wireless communications, and more particularly relates to methods and apparatuses for codebooks for 8TX UE with two coherent antenna groups.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Physical Uplink Shared Channel (PUSCH), codebook (CB), non-codebook (nCB), Sounding Reference Signal (SRS), Bandwidth part (BWP), Downlink Control Information (DCI), configured grant (CG), Transmission Reception Point (TRP), Light of Sight (LOS), Discrete Fourier Transform (DFT), Cyclic Prefix (CP), 3rd Generation Partnership Project (3GPP), Technical Specification (TS), Transmit Precoding Matrix Indicator (TPMI).

PUSCH transmission with 8 antenna ports (8Tx PUSCH) is supported in NR Release 18 for advanced UE equipped with 8 antennas with one or multiple layers.

This disclosure targets codebooks for 8TX UE with two coherent antenna groups.

### BRIEF SUMMARY

Methods and apparatuses for 8TX UE with two coherent antenna groups are disclosed.

In one embodiment, a UE comprises a transceiver; and a processor coupled to the transceiver, wherein the processor is configured to receive, via the transceiver, a control message scheduling a PUSCH transmission with transmission rank N to be transmitted by two antenna groups, wherein, the control message includes a TPMI that indicates two 4TX precoding matrices used by the two antenna groups, and the two 4TX precoding matrices are of the same type, wherein, N is any of 2 to 8; and transmit, via the transceiver, the scheduled PUSCH transmission according to the control message.

In some embodiment, the precoding matrices are classified into different types according to the number of active transmitting antenna ports and their relative phases.

In some embodiment, the TPMI indicates the two 4TX precoding matrices jointly from possible combinations of two precoding matrices.

In some embodiment, the TPMI includes a first part indicating a first precoding matrix from all possible precoding matrices of a predetermined rank and a second part indicating a second precoding matrix from a subset of possible precoding matrices determined by the first precoding matrix.

In some embodiment, if the transmission rank is 2, both 4TX precoding matrices are 4TX rank 1 precoding matrices; if the transmission rank is 3, the two 4TX precoding matrices are one 4TX rank 1 precoding matrix and one 4TX rank 2 precoding matrix; if the transmission rank is 4, both 4TX precoding matrices are 4TX rank 2 precoding matrices; if the transmission rank is 5, the two 4TX precoding matrices are one 4TX rank 2 precoding matrix and one 4TX rank 3 precoding matrix; if the transmission rank is 6, both 4TX precoding matrices are 4TX rank 3 precoding matrices; if the transmission rank is 7, the two 4TX precoding matrices are one 4TX rank 3 precoding matrix and one 4TX rank 4 precoding matrix; and if the transmission rank is 8, and both 4TX precoding matrices are 4TX rank 4 precoding matrices.

In some embodiment, the processor is further configured to construct a 8TX precoder from the two 4TX precoding matrices.

In some embodiment, the control message is a DCI format 0_1 or 0_2 that schedule dynamically scheduled PUSCH or type 2 configured grant PUSCH. Alternatively, the control message is a RRC message that schedules type 1 configured grant PUSCH.

In another embodiment, a method performed at a UE comprises receiving a control message scheduling a PUSCH transmission with transmission rank N to be transmitted by two antenna groups, wherein, the control message includes a TPMI that indicates two 4TX precoding matrices used by the two antenna groups, and the two 4TX precoding matrices are of the same type, wherein, N is any of 2 to 8; and transmitting the scheduled PUSCH transmission transmitted according to the control message.

In still another embodiment, a base unit comprises a transceiver; and a processor coupled to the transceiver, wherein the processor is configured to transmit, via the transceiver, a control message scheduling a PUSCH transmission with transmission rank N to be transmitted by two antenna groups, wherein, the control message includes a TPMI that indicates two 4TX precoding matrices used by the two antenna groups, and the two 4TX precoding matrices are of the same type, wherein, N is any of 2 to 8; and receive, via the transceiver, the scheduled PUSCH transmission transmitted according to the control message.

In yet another embodiment, a method performed at a base unit comprises transmitting a control message scheduling a PUSCH transmission with transmission rank N to be transmitted by two antenna groups, wherein, the control message includes a TPMI that indicates two 4TX precoding matrices used by the two antenna groups, and the two 4TX precoding matrices are of the same type, wherein, N is any of 2 to 8; and receiving the scheduled PUSCH transmission transmitted according to the control message.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates several antenna layouts with different number of antenna groups;

FIG. 2 is a schematic flow chart diagram illustrating an embodiment of a method;

FIG. 3 is a schematic flow chart diagram illustrating an embodiment of another method;

FIG. 4 is a schematic flow chart diagram illustrating an embodiment of a method;

FIG. 5 is a schematic flow chart diagram illustrating an embodiment of another method; and

FIG. 6 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

The UE can be configured in two different modes for PUSCH multi-antenna precoding, referred as codebook (CB) based transmission and non-codebook (nCB) based transmission, respectively. When the UE is configured with codebook based PUSCH transmission, one SRS resource set used for codebook can be configured in a BWP of a cell for the UE. When the UE is configured with non-codebook based PUSCH transmission, one SRS resource set used for non-codebook can be configured in a BWP of a cell for the UE.

To enable codebook based PUSCH transmission, the UE shall be configured to transmit one or more SRS resources used for codebook for uplink channel measurement. Based on the measurements on the configured SRS resources transmitted by the UE, the gNB determines a suitable transmission rank (which may be abbreviated as “rank” hereinafter) and the precoding matrix from a pre-defined codebook, which includes a set of precoding matrices with different ranks, and sends the information to the UE when scheduling a PUSCH transmission.

When a UE is equipped with 8 antenna ports (e.g., PUSCH or SRS antenna ports), the base unit (e.g., gNB) may send to the UE a DCI (e.g., DCI with format 0_1 or DCI with format 0_2) scheduling dynamically scheduled PUSCH or type 2 configured-grant PUSCH with up to 8 layers (i.e., PUSCH layers) or a RRC message (e.g., configuredGrantConfig) to configure type 1 configured-grant PUSCH with up to 8 layers. The 8 antenna ports (e.g., PUSCH or SRS antenna ports) may be numbered as PUSCH or SRS antenna ports 1000, 1001, 1002, 1003, 1004, 1005, 1006, and 1007. Incidentally, a brief summary of CG PUSCH is as follows. CG (configured grant) PUSCH is used for semi-static UL traffic, which can be transmitted without dedicated scheduling DCI. Two types of CG PUSCH are specified in NR Release 15. For type 1 CG PUSCH, all the information used for the PUSCH transmission are configured by RRC signaling and the CG PUSCH can be periodically transmitted according to the configured period. For type 2 CG PUSCH, part of information used for the PUSCH transmission is configured by RRC signaling, while the other information is indicated by an activation DCI. Type 2 CG PUSCH can only be periodically transmitted upon receiving the activation DCI. When the UE receives a deactivation DCI to deactivate type 2 CG PUSCH, the corresponding PUSCH shall not be transmitted. Both type 1 CG PUSCH and type 2 CG PUSCH are configured by configured grant PUSCH configuration (i.e., by higher layer parameter configuredGrantConfig IE) and each configuredGrantConfig has an ID.

When the PUSCH layers are transmitted from the UE, a precoding matrix is used to perform UL precoding on modulated data in codebook based PUSCH transmission. The UE shall perform UL precoding according to Equation 1.

$$[ \begin{matrix}{z}_{0}^{( {P}_{0} )} ( i ) \\ ⋮ \\ {z}_{0}^{( {P}_{ρ - 1} )} ( i )\end{matrix} ] = {W}_{0} [ \begin{matrix}{y}_{0}^{( 0 )} ( i ) \\ ⋮ \\ {y}_{0}^{( {v}_{0} - 1 )} ( i )\end{matrix} ] \qquad Equation 1$$

where, the block of vector

$${[ {y}_{0}^{( 0 )} ( i ) … {y}_{0}^{( {v}_{0} - 1 )} ( i ) ]}^{T}$$

is the modulated data that will be transmitted; W₀ is the precoding matrix applied to the block of vector; and the block of vector

$${[ {z}_{0}^{( {P}_{0} )} ( i ) … {z}_{0}^{( {P}_{ρ - 1} )} ( i ) ]}^{T}$$

is the pre-coded data to be transmitted by the UE. v₀ indicates the number of PUSCH layers or the rank of the PUSCH. P₀ corresponds to PUSCH antenna port 1000 and P_{ρ-1} corresponds to PUSCH antenna port 1000+ρ−1. In this invention, ρ=8.

Coherent transmission is described as follows:

If a UE reports a capability of full-coherent and 8 antenna ports (i.e., PUSCH antenna port 1000, 1001, 1002, 1003, 1004, 1005, 1006 and 1007), all 8 PUSCH antenna ports can be used for coherent transmission of a PUSCH layer. For example, the precoding vector used for each layer can have 8 non-zero elements, e.g.,

$$W = {\frac{1}{2 \sqrt{2}} [ 1 , j , 1 , j , 1 , j , 1 , j ]}^{T}$$

is a valid precoding vector for a rank 1 PUSCH transmission with 8 full coherent antenna ports. If the phase difference between any two antenna ports among multiple antenna ports is fixed, the multiple antenna ports are coherent. If the phase difference between any two antenna ports among multiple antenna ports is not fixed, the multiple antenna ports are non-coherent.

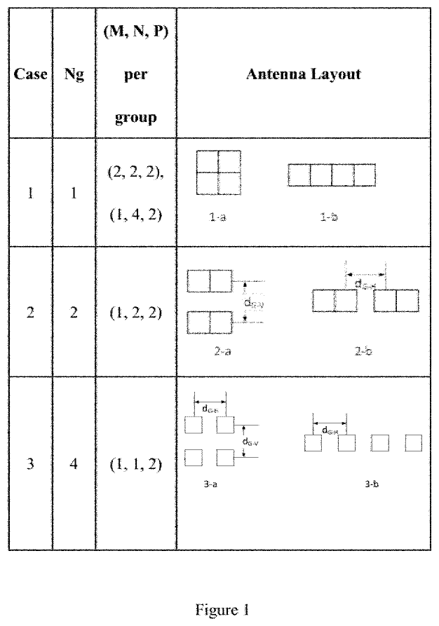

If a UE reports capability of partial-coherent or non-coherent with 8 antenna ports (i.e., PUSCH antenna port 1000, 1001, 1002, 1003, 1004, 1005, 1006 and 1007), only coherent antenna ports (where the coherent antenna ports are a part of the 8 antenna ports) can be used for transmission of one PUSCH layer. In particular, all 8 antenna ports are grouped as Ng antenna groups. All antenna ports within each antenna group are coherent, while antenna ports from different antenna groups are non-coherent. Several antenna layouts with different number of antenna groups are illustrated in FIG. 1.

In FIG. 1, Ng denotes the number of antenna groups. M denotes the number of antennas in vertical in an antenna group. N denotes the number of antennas in horizontal in an antenna group. P denotes the number of polarizations of each antenna. Each polarization of an antenna corresponds to an antenna port.

Antenna layout 1-a and antenna layout 1-b correspond to full coherent antenna array, i.e., all 8 antenna ports within each of antenna layout 1-a and antenna layout 1-b belong to one antenna group (e.g., antenna group #0, denoted as nNg=0) and are coherent antenna ports.

Antenna layout 2-a and antenna layout 2-b correspond to partial coherent antenna array with two antenna groups (Ng=2). For example, in each of antenna layout 2-a and antenna layout 2-b, each of antenna group #0 (a first antenna group, denoted as nNg=0) and antenna group #1 (a second antenna group, denoted as nNg=1) includes four coherent antenna ports.

Antenna layout 3-a and antenna layout 3-b correspond to partial coherent antenna array with four antenna groups (Ng=4). For example, in each of antenna layout 3-a and antenna layout 3-b, each of antenna group #0 (a first antenna group, denoted as nNg=0), antenna group #1 (a second antenna group, denoted as nNg=1), antenna group #2 (a third antenna group, denoted as nNg=2), and antenna group #3 (a fourth antenna group, denoted as nNg=3) includes two coherent antenna ports.

Before discussing the codebook design, the UE needs to report its antenna layout including the number of antenna groups 1≤Ng≤4, and optionally the antennas within each antenna group (M, N, P), where M indicates the number of antennas in horizontal, N indicates the number of antennas in vertical, P indicates the number of polarizations of each antenna. One polarization of each antenna corresponds to an antenna port. Each antenna group has the same antenna structure.

The UE can report the supported maxRank∈{1, 2, 3, 4, 5, 6, 7, 8}, i.e., the maximum number of PUSCH layers for a PUSCH transmission.

The gNB sends a DCI to the UE to schedule one or more PUSCH transmissions. The rank of the scheduled PUSCH transmission may be 1, 2, 3, 4, 5, 6, 7 or 8 depending on the reported maxRank. It means that the PUSCH transmission has L PUSCH layers, where L is equal to the rank, which is equal to or less than maxRank. A precoding matrix (which can also be referred to as precoder) shall be determined for the scheduled PUSCH transmission.

Incidentally, the number of columns of the precoding matrix indicates the number of layers of a PUSCH transmission for which the precoding matrix can be applied. So, precoding matrix (i.e., precoder) can be further described as rank R precoding matrix (precoder), e.g., rank 1 precoder, rank 2 precoder, rank 3 precoder, rank 4 precoder, rank 5 precoder, rank 6 precoder, rank 7 precoder, rank 8 precoder. Rank R precoding matrix (precoder) can be also denoted as R-layer precoding matrix (precoder), e.g., one-layer precoder (or single-layer precoder), two-layer precoder, three-layer precoder, four-layer precoder, five-layer precoder, six-layer precoder, seven-layer precoder, eight-layer precoder. The number of rows of the precoding matrix (precoder) indicates the number of antenna ports for which the precoding matrix can be applied. For example, the precoding matrix (precoder) may have 2 or 4 or 8 rows (denoted as 2Tx, 4TX, 8Tx) for a UE with 2 antenna ports or 4 antenna ports or 8 antenna ports.

This disclosure targets codebooks for 8TX UE (i.e., UE with 8 antenna ports) with two coherent antenna groups (i.e., Ng=2). When Ng=2, 8 antenna ports are arranged in two antenna groups, that are coherent and each has 4 antenna ports. Each box represents a pair of coherent cross-polarized antennas. It can be seen from FIG. 1 that the two antenna groups have the same layout, but are displaced from each other by a certain distance (d_{G-v} or d_{G-H}). This makes the channel H₁ from the first antenna group at the UE to the TRP, and the channel H₂ from the second antenna group at the UE to the TRP, strongly correlated. It suggests that if both antenna groups are used for transmission to the TRP, their best precoding matrices should be very similar, or at least have similar structures.

The transmission from the UE to the TRP can be represented as:

$$Y = HWX + N = [ {H}_{1} {H}_{2} ] [ \begin{matrix}{W}_{1} & 0 \\ 0 & {W}_{2}\end{matrix} ] [ \begin{matrix}{X}_{1} \\ {X}_{2}\end{matrix} ] + N = {H}_{1} {W}_{1} {X}_{1} + {H}_{2} {W}_{2} {X}_{2} + N ,$$

where Hᵢ,Wᵢ,Xᵢ are the channel, precoding matrix, and information from the antenna group i (i is 1 or 2) to the TRP respectively, and N is the receiver noise vector. As described above, H₁ and H₂ are correlated, where their correlation depends on the relative strengths of different multi-paths between the UE and the TRP. When the channel is dominated by a strong singular path, such as a LOS channel with a large Rician K factor, the two channels are highly correlated. This leads us to believe the best individual precoders for each antenna group in the absence of the other group are also strongly correlated. For highly correlated channel, these precoders of the same rank are also highly correlated or even identical. The strong correlation between the two channels and the two precoders will play different roles when the same information (rank1, X₁=X₂) or different information (rank 2-8, X₁≠X₂) are transmitted from the two groups. This can be used to describe the similarity (or dissimilarity) between the precoders.

This disclosure proposes that one precoding matrix (i.e., precoder) in NR Release 15 4TX codebook is used in each of the two antenna groups. The precoders in these codebooks can be classified into different types based on their structures (that is, the number of actively transmitting antenna ports and their relative phases), so that correlations between any two precoders can be established.

4TX rank 1 codebook is given by Table 6.3.1.5-2 (for DFT-s-OFDM) or Table 6.3.1.5-3 (for CP-OFDM) specified in 3GPP Technical Specification TS38.211 V16.0.0 as follows:

TABLE 6.3.1.5-2
Precoding matrix W for single-layer transmission using four antenna ports with
transform precoding enabled.

| | W | | | | | | | |
|---|---|---|---|---|---|---|---|---|
| TPMI index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\begin{matrix}1 \\ 2\end{matrix} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ - 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ 1\end{matrix} ]$ | $\frac{1}{2} [ \begin{matrix}1 \\ j \\ - 1 \\ j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ 1\end{matrix} ]$ | $\frac{1}{2} [ \begin{matrix}1 \\ - 1 \\ j \\ j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ - 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ 1\end{matrix} ]$ | — | — | — | — |

TABLE 6.3.1.5-3
Precoding matrix W for single-layer transmission using four antenna ports with
transform precoding disabled.

| | W | | | | | | | |
|---|---|---|---|---|---|---|---|---|
| TPMI index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

The rank 1 precoders (with TPMI index from 0 to 27) can be classified into three groups:

$${G}_{1}^{1} :$$

precoders with index of 0 to 3 (i.e., {TPMI 0-3}): port selection precoders, that is, one port is selected out of 4 ports for transmission.

$${G}_{2}^{1} :$$

precoders with index of 4 to 11 (i.e., {TPMI 4-11}): port-selection and co-phasing precoders, that is, a pair of antenna ports are selected for transmission and a co-phasing factor is applied to them.

$${G}_{3}^{1} :$$

precoders with index of 12 to 27 (i.e., {TPMI 12-27}): four ports co-phasing precoders, that is, all four ports are used for transmission and a co-phasing vector is applied to them.

The notion

$${G}_{l}^{k}$$

represents a group of 4TX precoders with transmission rank k and type t. The notion G^{k} represents all the 4TX precoders with transmission rank k, that is, the 4TX precoders with transmission rank k with all types.

In this disclosure, the 4TX precoders with each transmission rank k can be classified into three groups. The 4TX precoders with each transmission rank k in each of the three groups are of the same type. It means that each 4TX precoder with each transmission rank k can be of one of three types, e.g., type #1, type #2 and type #3.

For example, the rank 1 precoders (G¹) are classified into three types: type #1 of {TPMI 0-3}. i.e.,

$${G}_{1}^{1} ;$$

type #2 of {TPMI 4-11}, i.e.,

$${G}_{2}^{1} ;$$

and type #3 of {TPMI 12-27}, i.e.,

$${G}_{3}^{1} .$$

It is obvious that

$${G}^{1} = {G}_{1}^{1} ⋃ {G}_{2}^{1} ⋃ {G}_{3}^{1} = {⋃}_{t = 1}^{3} {G}_{t}^{1} .$$

4TX rank 2 codebook is given by Table 6.3.1.5-5 specified in 3GPP Technical Specification TS38.211 V16.0.0 as follow:

TABLE 6.3.1.5-5
Precoding matrix W for two-layer transmission using four antenna ports with
transform precoding disabled.

| | W | | | |
|---|---|---|---|---|
| TPMI index | (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - 1 & 0 \\ 0 & j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ | — | — |

The rank 2 precoders G, with TPMI index from 0 to 21) can be classified into three groups:
A first group with Type #1:

$${G}_{1}^{2}$$

includes precoders with index of 0 to 5 (i.e., {TPMI 0-5}): port selection precoders.
A second group with Type #2:

$${G}_{2}^{2}$$

includes precoders with index of 6 to 13 (i.e., {TPMI 6-13}): port-selection and co-phasing precoders.
A third group with Type #3:

$${G}_{3}^{2}$$

includes precoders with index of 14 to 21 (i.e., {TPMI 14-21}): four ports co-phasing precoders.

$${G}^{2} = {G}_{1}^{2} ⋃ {G}_{2}^{2} ⋃ {G}_{3}^{2} = {⋃}_{t = 1}^{3} {G}_{t}^{2} .$$

4TX rank 3 codebook is given by Table 6.3.1.5-6 specified in 3GPP Technical Specification TS38.211 V16.0.0 as follow:

TABLE 6.3.1.5-6
Precoding matrix W for three-layer transmission using four antenna ports with
transform precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |
| 4-6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ | — |

The rank 3 precoders (G³, with TPMI index from 0 to 6) can be classified into three groups:
A first group with Type #1:

$${G}_{1}^{3}$$

includes precoders with index of 0 (i.e., {TPMI 0}: port selection precoders.
A second group with Type #2:

$${G}_{2}^{3}$$

includes precoders with index of 1 to 2 (i.e., {TPMI 1-2}: port-selection and co-phasing precoders.
A third group with Type #3:

$${G}_{3}^{3}$$

includes precoders with index of 3 to 6 (i.e., {TPMI 3-6}: four ports co-phasing precoders.

$${G}^{3} = {G}_{1}^{3} ⋃ {G}_{2}^{3} ⋃ {G}_{3}^{3} = {⋃}_{t = 1}^{3} {G}_{t}^{3} .$$

4TX rank 4 codebook is given by Table 6.3.1.5-7 specified in 3GPP Technical Specification TS38.211 V16.0.0 as follow:

TABLE 6.3.1.5-7
Precoding matrix W for four-layer transmission using four antenna ports with
transform precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

The rank 4 precoders (G⁴, with TPMI index from 0 to 4) can be classified into three groups:
A first group with Type #1:

$${G}_{1}^{4}$$

includes precoders with index of 0 (i.e., {TPMI 0}): port selection precoders.
A second group with Type #2:

$${G}_{2}^{4}$$

includes precoders with index of 1 to 2 (i.e., {TPMI 1-2}): port-selection and co-phasing precoders.
A third group with Type #3:

$${G}_{3}^{4}$$

includes precoders with index of 3 to 6 (i.e., {TPMI 3-4}: four ports co-phasing precoders.

$${G}^{4} = {G}_{1}^{4} ⋃ {G}_{2}^{4} ⋃ {G}_{3}^{4} = {U}_{t = 1}^{3} {G}_{t}^{4} .$$

The types for each precoder in ranks 1 to 4 are listed in Table 1:

TABLE 1

| | 4TX | rank 1 | 4TX | rank 2 | 4TX | rank 3 | 4TX | rank 4 |
|---|---|---|---|---|---|---|---|---|
| | rank 1 | TPMI | rank 2 | TPMI | rank 3 | TPMI | rank 4 | TPMI |
| | precoders | index | precoders | index | precoders | index | precoders | index |
| Type#1 | ${G}_{1}^{1}$ | 0-3 | ${G}_{1}^{2}$ | 0-5 | ${G}_{1}^{3}$ | 0 | ${G}_{1}^{4}$ | 0 |
| Type#2 | ${G}_{2}^{1}$ | 4-11 | ${G}_{2}^{2}$ | 6-13 | ${G}_{2}^{3}$ | 1-2 | ${G}_{2}^{4}$ | 1-2 |
| Type#3 | ${G}_{3}^{1}$ | 12-27 | ${G}_{3}^{2}$ | 14-21 | ${G}_{3}^{3}$ | 3-6 | ${G}_{3}^{4}$ | 3-4 |

For precoders in each rank N (N=1 to 4), the precoders in the same type can be regarded as similar precoders. For example,

$${G}_{1}^{1} , {G}_{1}^{2} , {G}_{1}^{3} and {G}_{1}^{4} ,$$

that are of type #1, are similar precoders;

$${G}_{2}^{1} , {G}_{2}^{2} , {G}_{2}^{3} and {G}_{2}^{4} ,$$

that are of type #2, are similar precoder; and

$${G}_{3}^{1} , {G}_{3}^{2} , {G}_{3}^{3} and {G}_{3}^{4} ,$$

that are of type #3, are similar precoder. Based on the assumption that the same precoder or similar precoders shall be used in the two antenna groups, this disclosure proposes that only certain combinations of (A₁, A₂) are allowed, where A₁, A₂ are the precoders applied to the first and the second antenna groups, respectively, wherein, A₁ and A₂ are selected from the same type,

$$( {A}_{1} , {A}_{2} ) ∈ ( {G}_{t}^{{k}_{1}} , {G}_{t}^{{k}_{2}} ) ,$$

t∈(1,2,3), where k₁, k₂ are the number of layers (transmission ranks) transmitted from the first and the second antenna groups, respectively. The details of k₁, k₂ depend on the total transmission rank k=k₁+k₂ and the form of the precoders, and will be discussed in the following embodiments.

This disclosure proposes 8TX rank N precoders, where N is from 2 to 8.

A first embodiment relates 8TX rank 2 precoders.

With two layers, each layer is transmitted from one antenna group (e.g., a first layer is transmitted from the first antenna group, and a second layer is transmitted from the second antenna group), and the 8TX rank 2 precoder (i.e., 8×2 precoder or precoding matrix) takes the form

$${W}^{2} = \frac{1}{\sqrt{2}} [ \begin{matrix}{A}_{1} & 0 \\ 0 & {A}_{2}\end{matrix} ] ,$$

where, W² represents 8TX rank 2 precoders (i.e., 8TX rank 2 codebook), A₁ is a 4TX rank 1 precoder (or precoding vector) from G¹, i.e., A₁∈G¹, and A₂ is a 4TX rank 1 precoder (or precoding vector) from the same group (i.e.,

$${G}_{1}^{1} , {G}_{2}^{1} or {G}_{3}^{1} )$$

(that has the same type) as A₁. It means that only precoders (A₁, A₂) from the following combinations are allowed:

$$( {A}_{1} , {A}_{2} ) ∈ {W}^{2} = ( ( {G}_{1}^{1} , {G}_{1}^{1} ) ⋃ ( {G}_{2}^{1} , {G}_{2}^{1} ) ⋃ ( {G}_{3}^{1} , {G}_{3}^{1} ) ) ,$$

where, each of

$${G}_{t}^{1}$$

represents a group of precoders in type t in 4TX rank 1 codebook.

As described in Table 1,

$${G}_{1}^{1} - \{ TPMI 0 - 3 \}$$

in 4TX rank 1 codebook has four (4) elements;

$${G}_{2}^{1} = \{ TPMI 4 - 11 \}$$

in 4TX rank 1 codebook has eight (8) elements; and

$${G}_{3}^{1} = \{ TPMI 12 - 27 \}$$

in 4TX rank 1 codebook has sixteen (16) elements. The total number of states (A₁,A₂) in W² is

$${\sum }_{t = 1}^{3} ( {\vert {G}_{t}^{1} \vert}^{2} ) = 4 \times 4 + 8 \times 8 + 16 \times 16 = 16 + 64 + 256 = 336 ,$$

in which |A| represents the size (i.e., the number of elements) of group A.

Joint TPMI indication or separate TPMI indication can be used to indicate one of the 336 precoders in 8TX rank 2 codebook, i.e., indicate one of possible combinations of (A₁, A₂).

Joint TPMI indication for 8TX rank 2 codebook can be defined as in Table 2:

TABLE 2

| | |
|---|---|
| TPMI | W² = (A₁, A₂) (ordered from |
| index | left to right in increasing order of TPMI index) |

| | | | | |
|---|---|---|---|---|
| 0-3 | (0, 0) | (0, 1) | (0, 2) | (0, 3) |
| 4-7 | (1, 0) | (1, 1) | (1, 2) | (1, 3) |
| . . . | | | | |
| 332-335 | (27, 24) | (27, 25) | (27, 26) | (27, 27) |

In Table 2, each TPMI index indicates a possible combination of (A₁, A₂)∈

$${W}^{2} = ( ( {G}_{1}^{1} , {G}_{1}^{1} ) ⋃ ( {G}_{2}^{1} , {G}_{2}^{1} ) ⋃ ( {G}_{3}^{1} , {G}_{3}^{1} ) ) .$$

For example, the index of A₁ is in increasing order; and for the same index of A₁, the index of A₂ is in increasing order. That is, the possible combination of (A₁,A₂) is:

$$( {G}_{1}^{1} , {G}_{1}^{1} )$$

(that is, (0,0), (0,1), (0,2), (0,3), (1,0), . . . , (1,3), . . . (3,3)),

$$( {G}_{2}^{1} , {G}_{2}^{1} )$$

(that is, (4,4), (4,5), . . . (4,11), . . . , (11,4), (11,5), . . . , (11,11)) and

$$( {G}_{3}^{1} , {G}_{3}^{1} )$$

(that is, (12,12), (12,13), . . . , (12,27), . . . , (27,12), (27,13), . . . , (27,27)).

According to the joint TPMI indication, ┌log₂(336)┐(=9) bits are necessary for the TPMI field to indicate one of the 336 precoders in 8TX rank 2 codebook.

For separate TPMI indication, A₁ and A₂ can be separately indicated. That is, rank 2 TPMI can be divided into two parts TMPI1 and TMPI2, where TPMI1 (index from 0 to 27) indicates a precoder A₁ contained in G¹, and TPMI2 (index from 0 up to 15) indicates A₂ from the same group

$${G}_{t}^{1}$$

(t=1 or 2 or 3) as A₁. That is, when A₁ is in

$${G}_{1}^{1} ,$$

index 0-3 of A₂ indicates

$${G}_{1}^{1} = \{ TPMI 0 - 3 \}$$

in 4TX rank 1 codebook, respectively; when A₁ is in

$${G}_{2}^{1} ,$$

index 0-7 of A₂
indicates

$${G}_{2}^{1} = \{ TPMI 4 - 11 \}$$

in 4TX rank 1 codebook; when A₁ is in

$${G}_{3}^{1} ,$$

index 0-15 of A₂ indicates

$${G}_{3}^{1} = \{ TPMI 12 - 27 \}$$

in 4TX rank 1 codebook.

For example, {TPMI1=4, TPMI2=} indicates

$${A}_{1} = \frac{1}{2} = [ \begin{matrix}1 \\ 0 \\ 1 \\ 0\end{matrix} ] , {A}_{2} = \frac{1}{2} = [ \begin{matrix}1 \\ 0 \\ - 1 \\ 0\end{matrix} ] ,$$

in which TPMI1=4 indicates

$${A}_{1} = \frac{1}{2} [ \begin{matrix}1 \\ 0 \\ 1 \\ 0\end{matrix} ]$$

in G¹ (see Table 6.3.1.5-2 or Table 6.3.1.5-3), which is in group

$${G}_{2}^{1} ,$$

TPMI2=1 indicates index 1 in group

$${G}_{2}^{1} ( {A}_{2} = \frac{1}{2} [ \begin{matrix}1 \\ 0 \\ - 1 \\ 0\end{matrix} ] ) , 1$$

which is index 5 in G¹.

According to the separate TPMI indication, ┌log₂(28)┐ (for TPMI1)+┌log₂(16)┐ (for TPMI2)=5+4=9 bits are necessary for the TPMI field to indicate one of the 336 precoders in 8TX rank 2 codebook.

When A₁ and A₂ are determined, either based on joint TPMI indication or separate TPMI indication, a 8TX rank

$$precoder = \frac{1}{\sqrt{2}} [ \begin{matrix}{A}_{1} & 0 \\ 0 & {A}_{2}\end{matrix} ]$$

is constructed from A₁ and A₂.

$$For example , if {A}_{1} = \frac{1}{2} [ \begin{matrix}1 \\ 0 \\ 1 \\ 0\end{matrix} ] , {A}_{2} = \frac{1}{2} [ \begin{matrix}1 \\ 0 \\ - 1 \\ 0\end{matrix} ] ; then , {W}^{2} = \frac{1}{2 \sqrt{2}} [ \begin{matrix}1 & 0 \\ 0 & 0 \\ 1 & 0 \\ 0 & 0 \\ 0 & 1 \\ 0 & 0 \\ 0 & - 1 \\ 0 & 0\end{matrix} ] .$$

A second embodiment relates 8TX rank 3 precoders.

With three layers, a first layer is transmitted from the first antenna group, and a second layer and a third layer are transmitted from the second antenna group, the 8TX rank 3 precoder (i.e., the 8×3 precoder or precoding matrix) takes the form

$${W}^{3} = \frac{1}{\sqrt{2}} [ \begin{matrix}{A}_{1} & 0 \\ 0 & {A}_{2}\end{matrix} ] ,$$

where, W³ represents 8TX rank 3 precoders (i.e., 8TX rank 3 codebook), A₁ is a 4TX rank 1 precoder (or precoding vector) from G¹, i.e., A₁∈G¹, and A₂ is a 4TX rank 2 precoder (or precoding matrix) from the group (i.e.,

$${G}_{1}^{2} , {G}_{2}^{2} or {G}_{3}^{2} )$$

in G² that has the same type (i.e., type #1, type #2 or type #3) as A₁. It means that only precoders from the following combinations are allowed: (A₁,A₂)∈

$${W}^{3} = ( ( {G}_{1}^{1} , {G}_{1}^{2} ) ⋃ ( {G}_{2}^{1} , {G}_{2}^{2} ) ⋃ ( {G}_{3}^{1} , {G}_{3}^{2} ) ) ,$$

where, each of

$${G}_{t}^{1}$$

represents a group of precoders in type t in 4TX rank 1 codebook, each of

$${G}_{t}^{2}$$

represents a group of precoders in type t in 4TX rank 2 codebook. It can be seen that, although A₁ is a 4TX rank 1 precoder (precoding vector) from Table 6.3.1.5-2 or Table 6.3.1.5-3 and A₂ is a 4TX rank 2 precoder (precoding matrix) from Table 6.3.1.5-5, they have the same type (i.e., type #1, type #2 or type #3).

As described in Table 1,

$${G}_{1}^{1} = \{ TPMI 0 - 3 \}$$

in 4TX rank 1 codebook has four (4) elements;

$${G}_{2}^{1} = \{ / TPMI 4 - 11 \}$$

in 4TX rank 1 codebook has eight (8) elements; and

$${G}_{3}^{1} = \{ TPMI 12 - 27 \}$$

in 4TX rank 1 codebook has sixteen (16) elements, while

$${G}_{1}^{2} = \{ TPMI 0 - 5 \}$$

in 4TX rank 2 codebook has six (6) elements;

$${G}_{2}^{2} = \{ TPMI 6 - 13 \}$$

in 4TX rank 2 codebook has eight (8) elements; and

$${G}_{3}^{2} = \{ TPMI 14 - 22 \}$$

in 4TX rank 2 codebook has eight (8) elements. The total number of states (A₁,A₂) in W³ is

$${\sum }_{t = 1}^{3} ( \vert {G}_{t}^{1} \vert \vert {G}_{t}^{2} \vert ) - 4 \times 6 + 8 \times 8 + 16 \times 8 - 24 + 64 + 128 - 216.$$

Joint TPMI indication or separate TPMI indication can be used to indicate one of the 216 precoders in 8TX rank 3 codebook, i.e., indicate one of possible combinations of (A₁,A₂).

Joint TPMI indication for 8TX rank 3 codebook can be defined as in Table 3:

TABLE 3

| | |
|---|---|
| TPMI | W³ = (A₁, A₂) (ordered from |
| index | left to right in increasing order of TPMI index) |

| | | | | |
|---|---|---|---|---|
| 0-3 | (0, 0) | (0, 1) | (0, 2) | (0, 3) |
| 4-7 | (0, 4) | (0, 5) | (1, 0) | (1, 1) |
| . . . | | | | |
| 212-215 | (27, 18) | (27, 19) | (27, 20) | (27, 21) |

In Table 3, each TPMI index indicates a possible combination of (A₁,A₂)∈

$${W}^{3} = ( ( {G}_{1}^{1} , {G}_{1}^{2} ) ⋃ ( {G}_{2}^{1} , {G}_{2}^{2} ) ⋃ ( {G}_{3}^{1} , {G}_{3}^{2} ) ) .$$

For example, the index of A₁ is in increasing order; and for the same index of A₁, the index of A₂ is in increasing order. That is, the possible combination of (A₁, A₂) is:

$$( {G}_{1}^{1} , {G}_{1}^{2} )$$

(that is, (0,0), (0,1), (0,2), (0,3), (0,4), (0,5), (1,0), . . . , (1,5) . . . (3,5)),

$$( {G}_{2}^{1} , {G}_{2}^{2} )$$

(that is, (4,6), (4,7), . . . (4,13), . . . , (11,6), (11,7), . . . , (11,13)) and

$$( {G}_{3}^{1} , {G}_{3}^{2} )$$

(that is, (12,14), (12,15), . . . , (12,21), . . . , (27,14), (27,15), . . . , (27,21)).

According to the joint TPMI indication, ┌log₂(216)┐(=8) bits are necessary for the TPMI field to indicate one of the 216 precoders in 8TX rank 3 codebook.

For separate TPMI indication, A₁ and A₂ can be separately indicated. That is, rank 3 TPMI can be divided into two parts TMPI1 and TMPI2, where TPMI1 (index from 0 to 27) indicates a precoder A₁ contained in G¹, and TPMI2 (index from 0 up to 7) indicates A₂ from the group

$${G}_{t}^{2}$$

(t=1 or 2 or 3) that has the same type as A₁. That is, when A₁ is in

$${G}_{1}^{1} ,$$

index 0-5 of A₂ indicates

$${G}_{1}^{2} = \{ TPMI 0 - 5 \}$$

in 4TX rank 2 codebook, respectively; when A₁ is in

$${G}_{2}^{1} ,$$

index 0-7 of A₂ indicates

$${G}_{2}^{2} = \{ TPMI 6 - 13 \}$$

in 4TX rank 2 codebook; when A₁ is in

$${G}_{3}^{1} ,$$

index 0-7 of A₂ indicates

$${G}_{3}^{2} = \{ TPMI 14 - 21 \}$$

in 4TX rank 2 codebook.

$$For example , \{ TPMI 1 = 4 , TPMI 2 = 1 \} indicates {A}_{1} = \frac{1}{2} [ \begin{matrix}1 \\ 0 \\ 1 \\ 0\end{matrix} ] , {A}_{2} = \frac{1}{2} [ \begin{matrix}1 & 0 \\ 0 & 1 \\ 1 & 0 \\ 0 & j\end{matrix} ] ,$$

in which TPMI1=4 indicates

$${A}_{1} = \frac{1}{2} [ \begin{matrix}1 \\ 0 \\ 1 \\ 0\end{matrix} ]$$

in G¹ (see Table 6.3.1.5-2 or Table 6.3.1.5-3), which is in group

$${G}_{2}^{1} ( type \#2 ) ,$$

TPMI2=1 indicates index 1 in group

$${G}_{2}^{2} ( type \#2 ) ( {A}_{2} = \frac{1}{2} [ \begin{matrix}1 & 0 \\ 0 & 1 \\ 1 & 0 \\ 0 & j\end{matrix} ] ) ,$$

which is index 7 in G² (see Table 6.3.1.5-5).

According to the separate TPMI indication, ┌log₂(28)┐ (for TPMI1)+┌log₂(8)┐ (for TPMI2)=5+3=8 bits are necessary for the TPMI field to indicate one of the 216 precoders in 8TX rank 3 codebook.

When A₁ and A₂ are determined, either based on joint TPMI indication or separate TPMI indication, a 8TX rank 3

$$precoder = \frac{1}{\sqrt{2}} [ \begin{matrix}{A}_{1} & 0 \\ 0 & {A}_{2}\end{matrix} ]$$

is constructed from A₁ and A₂.

$$For example , if {A}_{1} = \frac{1}{2} [ \begin{matrix}1 \\ 0 \\ 1 \\ 0\end{matrix} ] , {A}_{2} = \frac{1}{2} [ \begin{matrix}1 & 0 \\ 0 & 1 \\ 1 & 0 \\ 0 & j\end{matrix} ] , then {W}^{3} = \frac{1}{2 \sqrt{2}} [ \begin{matrix}1 & 0 & 0 \\ 0 & 0 & 0 \\ 1 & 0 & 0 \\ 0 & 0 & 0 \\ 0 & 1 & 0 \\ 0 & 0 & 1 \\ 0 & 1 & 0 \\ 0 & 0 & j\end{matrix} ] .$$

A third embodiment relates 8TX rank 4 precoders.

With four layers, a first layer and a second layer are transmitted from the first antenna group, and a third layer and a fourth layer are transmitted from the second antenna group. The 8TX rank 4 precoder (i.e., 8×4 precoder or precoding matrix) takes the form

$${W}^{4} = \frac{1}{\sqrt{2}} [ \begin{matrix}{A}_{1} & 0 \\ 0 & {A}_{2}\end{matrix} ] ,$$

where, W⁴ represents 8TX rank 4 precoders (i.e., 8TX rank 4 codebook), A₁ is a 4TX rank 2 precoder (or precoding matrix) from G², i.e., A₁∈G², and A₂ is a 4TX rank 2 precoder (or precoding matrix) from the same group (i.e.,

$${G}_{1}^{2} , {G}_{2}^{2} or {G}_{3}^{2} )$$

(that has the same type) as A₁. It means that only precoders from the following combinations are allowed: (A₁,A₂)∈

$${W}^{4} = ( ( {G}_{1}^{2} , {G}_{1}^{2} ) ⋃ ( {G}_{2}^{2} , {G}_{2}^{2} ) ⋃ ( {G}_{3}^{2} , {G}_{3}^{2} ) ) ,$$

where, each of

$${G}_{t}^{2}$$

represents a group of precoders in type t in 4TX rank 2 codebook.

As described in Table 1,

$${G}_{1}^{2} = \{ TPMI 0 - 5 \}$$

in 4TX rank 2 codebook has six (6) elements;

$${G}_{2}^{2} = \{ TPMI 6 - 13 \}$$

in 4TX rank 2 codebook has eight (8) elements; and

$${G}_{3}^{2} = \{ TPMI 14 - 21 \}$$

in 4TX rank 2 codebook has eight (8) elements. The total number of states (A₁, A₂) in

$${W}^{4} = ( ( {G}_{1}^{2} , {G}_{1}^{2} ) ⋃ ( {G}_{2}^{2} , {G}_{2}^{2} ) ⋃ ( {G}_{3}^{2} , {G}_{3}^{2} ) ) is {\sum }_{t = 1}^{3} ( {\vert {G}_{t}^{2} \vert}^{2} ) = 6 \times 6 + 8 \times 8 + 8 \times 8 = 36 + 64 + 64 = 164.$$

Joint TPMI indication or separate TPMI indication can be used to indicate one of the 164 precoders in 8TX rank 4 codebook, i.e., indicate one of possible combinations of (A₁,A₂).

Joint TPMI indication for 8TX rank 4 codebook can be defined as in Table 4:

TABLE 4

| | |
|---|---|
| TPMI | W⁴ = (A₁, A₂) (ordered from |
| index | left to right in increasing order of TPMI index) |

| | | | | |
|---|---|---|---|---|
| 0-3 | (0, 0) | (0, 1) | (0, 2) | (0, 3) |
| 4-7 | (0, 4) | (0, 5) | (1, 0) | (1, 1) |
| . . . | | | | |
| 160-163 | (21, 18) | (21, 19) | (21, 20) | (21, 21) |

In Table 4, each TPMI index indicates a possible combination of (A₁, A₂)∈

$${W}^{4} = ( ( {G}_{1}^{2} , {G}_{1}^{2} ) ⋃ ( {G}_{2}^{2} , {G}_{2}^{2} ) ⋃ ( {G}_{3}^{2} , {G}_{3}^{2} ) ) .$$

For example, the index of A₁ is in increasing order; and for the same index of A₁, the index of A₂ is in increasing order. That is, the possible combination of (A₁,A₂) is:

$$( {G}_{1}^{2} , {G}_{1}^{2} )$$

(that is, (0,0), (0,1), (0,2), (0,3), (0,4), (0,5), (1,0), . . . , (1,5), . . . (5,5)),

$$( {G}_{2}^{2} , {G}_{2}^{2} )$$

(that is, (6,6), (6,7), . . . (6,13), . . . , (13,6), (13,7), . . . , (13,13)) and

$$( {G}_{3}^{2} , {G}_{3}^{2} )$$

(that is, (14,14), (14,15), . . . , (14,21), . . . , (21,14), (21,15), . . . , (21,21)).

According to the joint TPMI indication, ┌log₂(164)┐(=8) bits are necessary for the TPMI field to indicate one of the 164 precoders in 8TX rank 4 codebook.

For separate TPMI indication, A₁ and A₂ can be separately indicated. That is, rank 4 TPMI can be divided into two parts TMPI1 and TMPI2, where TPMI1 (index from 0 to 21) indicates a precoder A₁ contained in G², and TPMI2 (index from 0 up to 7) indicates A₂ from same group

$${G}_{t}^{2}$$

(t=1 or 2 or 3) as A₁. That is, when A₁ is in

$${G}_{1}^{2} ,$$

index 0-5 of A₂ indicates

$${G}_{1}^{2} = \{ TPMI 0 - 5 \}$$

in 4TX rank 2 codebook, respectively; when A₁ is in

$${G}_{2}^{2} ,$$

index 0-7 of A₂ indicates

$${G}_{2}^{2} = \{ TPMI 6 - 13 \}$$

in 4TX rank 2 codebook; when A₁ is in

$${G}_{3}^{2} ,$$

index 0-7 of A₂ indicates

$${G}_{3}^{2} = \{ TPMI 14 - 21 \}$$

in 4TX rank 2 codebook.

For example, {TPMI1=4, TPMI2=} indicates

$${A}_{1} = \frac{1}{2} [ \begin{matrix}0 & 0 \\ 1 & 0 \\ 0 & 0 \\ 0 & 1\end{matrix} ] , {A}_{2} = \frac{1}{2} [ \begin{matrix}1 & 0 \\ 0 & 0 \\ 0 & 1 \\ 0 & 0\end{matrix} ] ,$$

in which TPMI1=4 indicates

$${A}_{1} = \frac{1}{2} [ \begin{matrix}0 & 0 \\ 1 & 0 \\ 0 & 0 \\ 0 & 1\end{matrix} ]$$

in G² (see Table 6.3.1.5-5), which is group

$${G}_{1}^{2}$$

(type #1), TPMI2=1 indicates index 1 in group

$${G}_{1}^{2}$$

(type #1)

$$( {A}_{2} = \frac{1}{2} [ \begin{matrix}1 & 0 \\ 0 & 0 \\ 0 & 1 \\ 0 & 0\end{matrix} ] ) ,$$

which is index 1 in G² (see Table 6.3.1.5-5).

According to the separate TPMI indication, ┌log₂(21)┐ (for TPMI1)+┌log₂(8)┐ (for TPMI2)=5+3=8 bits are necessary for the TPMI field to indicate one of the 164 precoders in 8TX rank 4 codebook.

When A₁ and A₂ are determined, either based on joint TPMI indication or separate TPMI indication, a 8TX rank 4

$$precoder = \frac{1}{\sqrt{2}} [ \begin{matrix}{A}_{1} & 0 \\ 0 & {A}_{2}\end{matrix} ]$$

is constructed from A₁ and A₂.

$$For example , if {A}_{1} = \frac{1}{2} [ \begin{matrix}0 & 0 \\ 1 & 0 \\ 0 & 0 \\ 0 & 1\end{matrix} ] , {A}_{2} = \frac{1}{2} [ \begin{matrix}1 & 0 \\ 0 & 0 \\ 0 & 1 \\ 0 & 0\end{matrix} ] , then {W}^{4} = \frac{1}{2 \sqrt{2}} [ \begin{matrix}0 & 0 & 0 & 0 \\ 1 & 0 & 0 & 0 \\ 0 & 0 & 0 & 0 \\ 0 & 1 & 0 & 0 \\ 0 & 0 & 1 & 0 \\ 0 & 0 & 0 & 0 \\ 0 & 0 & 0 & 1 \\ 0 & 0 & 0 & 0\end{matrix} ]$$

A fourth embodiment relates 8TX rank 5 precoders.

With five layers, a first layer and a second layer are transmitted from the first antenna group, and a third layer, a fourth layer and a fifth layer arc transmitted from the second antenna group. The 8TX rank 5 precoder (i.e., the 8×5 precoder or precoding matrix) takes the form

$${W}^{5} = \frac{1}{\sqrt{2}} [ \begin{matrix}{A}_{1} & 0 \\ 0 & {A}_{2}\end{matrix} ] ,$$

where, W⁵ represents 8TX rank 5 precoders (i.e., 8TX rank 5 codebook), A₁ is a 4TX rank 2 precoder (or precoding matrix) from G², i.e., A₁ E G², and A₂ is a 4TX rank 3 precoder (or precoding matrix) from the group (i.e.,

$${G}_{1}^{3} , {G}_{2}^{3} or {G}_{3}^{3} )$$

in G³ that has the same type (i.e., type #1, type #2 or type #3) as A₁. It means that only precoders from the following combinations are allowed: (A₁, A₂)∈

$${W}^{5} = ( ( {G}_{1}^{2} , {G}_{1}^{3} ) ⋃ ( {G}_{2}^{2} , {G}_{2}^{3} ) ⋃ ( {G}_{3}^{2} , {G}_{3}^{3} ) ) ,$$

where each of

$${G}_{t}^{2}$$

represents a group of precoders in type t in 4TX rank 2 codebook, each of

$${G}_{t}^{3}$$

represents a group of precoders in type t in 4TX rank 3 codebook. It can be seen that, although A₁ is a 4TX rank 2 precoder (precoding matrix) from Table 6.3.1.5-5 and A₂ is a 4TX rank 3 precoder (precoding matrix) from Table 6.3.1.5-6, they have the same type (i.e., type #1, type #2 or type #3).

As described in Table 1,

$${G}_{1}^{2} = \{ TPMI 0 - 5 \}$$

in 4TX rank 2 codebook has six (6) elements;

$${G}_{2}^{2} = \{ TPMI 6 - 13 \}$$

in 4TX rank 2 codebook has eight (8) elements; and

$${G}_{3}^{2} = \{ TPMI 14 - 21 \}$$

in 4TX rank 2 codebook has eight (8) elements, while

$${G}_{1}^{3} = \{ TPMI 0 \}$$

in 4TX rank 3 codebook has one (1) element;

$${G}_{2}^{3} = \{ TPMI 1 - 2 \}$$

in 4TX rank 3 codebook has two (2) elements; and

$${G}_{3}^{3} = \{ TPMI 3 - 6 \}$$

in 4TX rank 3 codebook has four (4) elements. The total number of states (A₁,A₂) in

$${W}^{5} is {\sum }_{t = 1}^{3} ( \vert {G}_{t}^{2} ‖ {G}_{t}^{3} \vert ) = 6 \times 1 + 8 \times 2 + 8 \times 4 = 6 + 16 + 32 = 54.$$

Joint TPMI indication or separate TPMI indication can be used to indicate one of the 54 precoders in 8TX rank 5 codebook, i.e., indicate one of possible combinations of (A₁,A₂).

Joint TPMI indication for 8TX rank 5 codebook can be defined as in Table 5:

TABLE 5

| | |
|---|---|
| TPMI | W⁵ = (A₁, A₂) (ordered from |
| index | left to right in increasing order of TPMI index) |

| | | | | |
|---|---|---|---|---|
| 0-3 | (0, 0) | (1, 0) | (2, 0) | (3, 0) |
| 4-7 | (4, 0) | (5, 0) | (6, 1) | (6, 2) |
| . . . | | | | |
| 52-53 | (21, 5) | (21, 6) | — | — |

In Table 5, each TPMI index indicates a possible combination of (A₁,A₂)∈

$${W}^{5} = ( ( {G}_{1}^{2} , {G}_{1}^{3} ) ⋃ ( {G}_{2}^{2} , {G}_{2}^{3} ) ⋃ ( {G}_{3}^{2} , {G}_{3}^{3} ) ) .$$

For example, the index of A₁ is in increasing order; and for the same index of A₁, the index of A₂ is in increasing order. That is, the possible combination of (A₁,A₂) is:

$$( {G}_{1}^{2} , {G}_{1}^{3} )$$

(that is, (0,0), (1,0), (2,0), (3,0), (4,0), (5,0)),

$$( {G}_{2}^{2} , {G}_{2}^{3} )$$

(that is, (6,1), (6,2), . . . , (13,1), (13,2)),

$$( {G}_{3}^{2} , {G}_{3}^{3} )$$

(that is, (14,3), (14,4), . . . , (14,6), . . . , (21,3), (21,4), . . . , (21,6)).

According to the joint TPMI indication, ┌log₂(54)┐(=6) bits are necessary for the TPMI field to indicate one of the 54 precoders in 8TX rank 5 codebook.

For separate TPMI indication, A₁ and A₂ can be separately indicated. That is, rank 5 TPMI can be divided into two parts TMPI1 and TMPI2, where TPMI1 (index from 0 to 21) indicates a precoder A₁ contained in G², and TPMI2 (index from 0 up to 3) indicates A₂ from the group

$${G}_{t}^{3}$$

(t=1 or 2 or 3) that has the same type as A₁. That is, when A₁ is in

$${G}_{1}^{2} ,$$

index 0 of A₂ indicates

$${G}_{1}^{3} = \{ TPMI 0 \}$$

in 4TX rank 3 codebook; when A₁ is in

$${G}_{2}^{2} ,$$

index 0-1 of A₂ indicates

$${G}_{2}^{3} = \{ TPMI 1 - 2 \}$$

in 4TX rank 3 codebook; when A₁ is in

$${G}_{3}^{2} ,$$

index 0-3 of A₂ indicates

$${G}_{3}^{3} = \{ TPMI 3 - 6 \}$$

in 4TX rank 3 codebook.

For example, {TPMI1=6, TPMI2=1} indicates

$${A}_{1} = \frac{1}{2} [ \begin{matrix}1 & 0 \\ 0 & 1 \\ 1 & 0 \\ 0 & - j\end{matrix} ] , {A}_{2} = \frac{1}{2} [ \begin{matrix}1 & 0 & 0 \\ 0 & 1 & 0 \\ - 1 & 0 & 0 \\ 0 & 0 & 1\end{matrix} ]$$

in which TPMI1=6 indicates

$${A}_{1} = \frac{1}{2} [ \begin{matrix}1 & 0 \\ 0 & 1 \\ 1 & 0 \\ 0 & - j\end{matrix} ]$$

in G² (see Table 6.3.1.5-5), which is in group

$${G}_{2}^{2}$$

(type #2), TPMI2=1 indicates index 1 in group

$${G}_{2}^{3}$$

(type #2)

$$( {A}_{2} = \frac{1}{2} [ \begin{matrix}1 & 0 & 0 \\ 0 & 1 & 0 \\ - 1 & 0 & 0 \\ 0 & 0 & 1\end{matrix} ] ) ,$$

which is index 2 in G³ (see Table 6.3.1.5-6).

According to the separate TPMI indication, ┌log₂(21)┐ (for TPMI1)+┌log₂(4)┐ (for TPMI2)=5+2=7 bits are necessary for the TPMI field to indicate one of the 54 precoders in 8TX rank 5 codebook.

When A₁ and A₂ are determined, either based on joint TPMI indication or separate TPMI indication, a 8TX rank 5

$$precoder = \frac{1}{\sqrt{2}} [ \begin{matrix}{A}_{1} & 0 \\ 0 & {A}_{2}\end{matrix} ]$$

is constructed from A₁ and A₂.

$$For example , if {A}_{1} = \frac{1}{2} [ \begin{matrix}1 & 0 \\ 0 & 1 \\ 1 & 0 \\ 0 & - j\end{matrix} ] , {A}_{2} = \frac{1}{2} [ \begin{matrix}1 & 0 & 0 \\ 0 & 1 & 0 \\ - 1 & 0 & 0 \\ 0 & 0 & 1\end{matrix} ] , then {W}^{5} = \frac{1}{2 \sqrt{2}} [ \begin{matrix}1 & 0 & 0 & 0 & 0 \\ 0 & 1 & 0 & 0 & 0 \\ 1 & 0 & 0 & 0 & 0 \\ 0 & - j & 0 & 0 & 0 \\ 0 & 0 & 1 & 0 & 0 \\ 0 & 0 & 0 & 1 & 0 \\ 0 & 0 & - 1 & 0 & 0 \\ 0 & 0 & 0 & 0 & 1\end{matrix} ] .$$

A fifth embodiment relates 8TX rank 6 precoders.

With sixth layers, a first layer, a second layer and a third layer are transmitted from the first antenna group, and a fourth layer, a fifth layer and a sixth layer are transmitted from the second antenna group. The 8TX rank 6 precoder (i.e., 8×6 precoder or precoding matrix) takes the form

$${W}^{6} = \frac{1}{\sqrt{2}} [ \begin{matrix}{A}_{1} & 0 \\ 0 & {A}_{2}\end{matrix} ] ,$$

where, W⁶ represents 8TX rank 6 precoders (i.e., 8TX rank 6 codebook), A₁ is a 4TX rank 3 precoder (or precoding matrix) from G³, i.e., A₁ E G³, and A₂ is a 4TX rank 3 precoder (or precoding matrix) from the same group (i.e.,

$${G}_{1}^{3} , {G}_{2}^{3} or {G}_{3}^{3} )$$

(that has the same type) as A₁. It means that only precoders from the following combinations are allowed: (A₁,A₂)∈

$${W}^{6} = ( ( {G}_{1}^{3} , {G}_{1}^{3} ) ⋃ ( {G}_{2}^{3} , {G}_{2}^{3} ) ⋃ ( {G}_{3}^{3} , {G}_{3}^{3} ) ) ,$$

where each of

$${G}_{t}^{3}$$

represents a group of precoders in type t in 4TX rank 3 codebook.

As described in Table 1,

$${G}_{1}^{3} = \begin{matrix}\{ TPMI & 0 \}\end{matrix}$$

in 4TX rank 3 codebook has one (1) element;

$${G}_{2}^{3} = \begin{matrix}\{ TPMI & 1 - 2 \}\end{matrix}$$

in 4TX rank 3 codebook has two (2) elements; and

$${G}_{3}^{3} = \begin{matrix}\{ TPMI & 3 - 6 \}\end{matrix}$$

in 4TX rank 3 codebook has four (4) elements. The total number of states (A₁, A₂) in

$${W}^{6} = ( ( {G}_{1}^{3} , {G}_{1}^{3} ) ⋃ ( {G}_{2}^{3} , {G}_{2}^{3} ) ⋃ ( {G}_{3}^{3} , {G}_{3}^{3} ) ) is {\sum }_{t = 1}^{3} ( {\vert {G}_{t}^{3} \vert}^{2} ) = 1 \times 1 + 2 \times 2 + 4 \times 4 = 1 + 4 + 16 = 21.$$

Joint TPMI indication or separate TPMI indication can be used to indicate one of the 21 precoders in 8TX rank 6 codebook, i.e., indicate one of possible combinations of (A₁,A₂).

Joint TPMI indication for 8TX rank 6 codebook can be defined as in Table 6:

TABLE 6

| | |
|---|---|
| TPMI | W⁶ = (A₁, A₂) (ordered from |
| index | left to right in increasing order of TPMI index) |

| | | | | |
|---|---|---|---|---|
| 0-3 | (0, 0) | (1, 1) | (1, 2) | (2, 1) |
| 4-7 | (2, 2) | (3, 3) | (3, 4) | (3, 5) |
| 8-11 | (3, 6) | (4, 3) | (4, 4) | (4, 5) |
| 12-15 | (4, 6) | (5, 3) | (5, 4) | (5, 5) |
| 16-19 | (5, 6) | (6, 3) | (6, 4) | (6, 5) |
| 20 | (6, 6) | — | — | — |

In Table 6, each TPMI index indicates a possible combination of (A₁, A₂)∈

$${W}^{6} = ( ( {G}_{1}^{3} , {G}_{1}^{3} ) ⋃ ( {G}_{2}^{3} , {G}_{2}^{3} ) ⋃ ( {G}_{3}^{3} , {G}_{3}^{3} ) ) .$$

For example, the index of A₁ is in increasing order; and for the same index of A₁ the index of A₂ is in increasing order. That is, the possible combination of (A₁,A₂) is:

$$( {G}_{1}^{3} , {G}_{1}^{3} )$$

(that is, (0,0)),

$$( {G}_{2}^{3} , {G}_{2}^{3} )$$

(that is, (1,1), (1,2), (2,1), (2,2)) and

$$( {G}_{3}^{3} , {G}_{3}^{3} )$$

(that is, (3,3), (3,4), (3,5), (3,6), (4,3), (4,4), (4,5), (4,6), (5,3), (5,4), (5,5), (5,6), (6,3), (6,4), (6,5), (6,6)).

According to the joint TPMI indication, ┌log₂(21)┐(=5) bits are necessary for the TPMI field to indicate one of the 21 precoders in 8TX rank 6 codebook.

For separate TPMI indication, A₁ and A₂ can be separately indicated. That is, rank 6 TPMI can be divided into two parts TMPI1 and TMPI2, where TPMI1 (index from 0 to 6) indicates a precoder A₁ contained in G³, and TPMI2 (index from 0 up to 3) indicates A₂ from the same group

$${G}_{t}^{3}$$

(t=1 or 2 or 3) as A₁. That is, when A₁ is in

$${G}_{1}^{3} ,$$

index 0 of A₂ indicates

$${G}_{1}^{3} = \begin{matrix}\{ TPMI & 0 \}\end{matrix}$$

in 4TX rank 3 codebook; when A₁ is in

$${G}_{2}^{3} ,$$

index 0-1 of A₂ indicates

$${G}_{2}^{3} = \{ TPMI$$

in 4TX rank 3 codebook; when A₁ is in

$${G}_{3}^{3} ,$$

index 0-3 of A₂ indicates

$${G}_{3}^{3} = \begin{matrix}\{ TPMI & 3 - 6\end{matrix} \}$$

in 4TX rank 3 codebook.

For example, {TPMI1=1, TPMI2=1} indicates

$${A}_{1} = \frac{1}{2} [ \begin{matrix}1 & 0 & 0 \\ 0 & 1 & 0 \\ 1 & 0 & 0 \\ 0 & 0 & 1\end{matrix} ] , {A}_{2} = \frac{1}{2} [ \begin{matrix}1 & 0 & 0 \\ 0 & 1 & 0 \\ - 1 & 0 & 0 \\ 0 & 0 & 1\end{matrix} ] ,$$

in which TPMI1=1 indicates

$${A}_{1} = \frac{1}{2} [ \begin{matrix}1 & 0 & 0 \\ 0 & 1 & 0 \\ 1 & 0 & 0 \\ 0 & 0 & 1\end{matrix} ]$$

in G³ (see Table 6.3.1.5-6), which is group

$${G}_{2}^{3}$$

(type #2), TPMI2=1 indicates index 1 in group G

$${G}_{2}^{3}$$

(type #2)

$$( {A}_{2} = \frac{1}{2} [ \begin{matrix}1 & 0 & 0 \\ 0 & 1 & 0 \\ - 1 & 0 & 0 \\ 0 & 0 & 1\end{matrix} ] ) ,$$

which is index 2 in G³ (see Table 6.3.1.5-6).

According to the separate TPMI indication, ┌log₂(7)┐ (for TPMI1)+┌log₂(4)┌ (for TPMI2) 3+2 5 bits are necessary for the TPMI field to indicate one of the 21 precoders in 8TX rank 6 codebook.

When A₁ and A₂ are determined, either based on joint TPMI indication or separate TPMI indication, a 8TX rank 6

$$precoder = \frac{1}{\sqrt{2}} [ \begin{matrix}{A}_{1} & 0 \\ 0 & {A}_{2}\end{matrix} ]$$

is constructed from A₁ and A₂. For example,

$$if {A}_{1} = \frac{1}{2} [ \begin{matrix}1 & 0 & 0 \\ 0 & 1 & 0 \\ 1 & 0 & 0 \\ 0 & 0 & 1\end{matrix} ] , {A}_{2} = \frac{1}{2} [ \begin{matrix}1 & 0 & 0 \\ 0 & 1 & 0 \\ - 1 & 0 & 0 \\ 0 & 0 & 1\end{matrix} ] , then {W}^{6} = \frac{1}{2 \sqrt{2}} [ \begin{matrix}1 & 0 & 0 & 0 & 0 & 0 \\ 0 & 1 & 0 & 0 & 0 & 0 \\ 1 & 0 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & - 1 & 0 & 0 \\ 0 & 0 & 0 & 0 & 0 & 1\end{matrix} ] .$$

A sixth embodiment relates 8TX rank 7 precoders.

With seven layers, a first layer, a second layer and a third layer are transmitted from the first antenna group, and a fourth layer, a fifth layer, a sixth layer and a seventh layer are transmitted from the second antenna group. The 8TX rank 7 precoder (i.e., the 8×7 precoder or precoding matrix) takes the form

$${W}^{7} = \frac{1}{\sqrt{2}} [ \begin{matrix}{A}_{1} & 0 \\ 0 & {A}_{2}\end{matrix} ] ,$$

where, W⁷ represents 8TX rank 7 precoders (i.e., 8TX rank 7 codebook), A₁ is a 4TX rank 3 precoder (or precoding matrix) from G³, i.e., A₁∈G³, and A₂ is a 4TX rank 4 precoder (or precoding matrix) from the group (i.e.

$${G}_{1}^{4} , {G}_{2}^{4} or {G}_{3}^{4} )$$

in G⁴ that has the same type (i.e., type #1, type #2 or type #3) as A₁. It means that only precoders from the following combinations are allowed: (A₁,A₂)∈

$${W}^{7} = ( ( {G}_{1}^{3} , {G}_{1}^{4} ) ⋃ ( {G}_{2}^{3} , {G}_{2}^{4} ) ⋃ ( {G}_{3}^{3} , {G}_{3}^{4} ) ) ,$$

where each of

$${G}_{t}^{3}$$

represents a group of precoders in type t in 4TX rank 3 codebook, each of

$${G}_{t}^{4}$$

represents a group of precoders in type tin 4TX rank 4 codebook. It can be seen that, although A₁ is a 4TX rank 3 precoder (precoding matrix) from Table 6.3.1.5-6 and A₂ is a 4TX rank 4 precoder (precoding matrix) from Table 6.3.1.5-7, they have the same type (i.e., type #1, type #2 or type #3).

As described in Table 1,

$${G}_{1}^{3} = \begin{matrix}\{ TPMI & 0\end{matrix} \}$$

in 4TX rank 3 codebook has one (1) element;

$${G}_{2}^{3} = \begin{matrix}\{ TPMI & 1 - 2\end{matrix} \}$$

in 4TX rank 3 codebook has two (2) elements; and

$${G}_{3}^{3} = \begin{matrix}\{ TPMI & 3 - 6\end{matrix} \}$$

in 4TX rank 3 codebook has four (4) elements, while

$${G}_{1}^{4} = \begin{matrix}\{ TPMI & 0\end{matrix} \}$$

in 4TX rank 4 codebook has one (1) element;

$${G}_{2}^{4} = \begin{matrix}\{ TPMI & 1 - 2\end{matrix} \}$$

in 4TX rank 4 codebook has two (2) elements; and

$${G}_{3}^{4} = \{ TPMI {\sum }_{t = 1}^{3} ( \vert {G}_{t}^{3} \vert \vert {G}_{t}^{4} \vert ) = 1 \times 1 + 2 \times 2 + 4 \times 2 = 1 + 4 + 8 = 13 .$$

in 4TX rank 4 codebook has two (2) elements. The total number of states (A₁,A₂) in W⁷ is

$${\sum }_{t = 1}^{3} ( \vert {G}_{t}^{3} \vert \vert {G}_{t}^{4} \vert ) = 1 \times 1 + 2 \times 2 + 4 \times 2 = 1 + 4 + 8 = 13 .$$

Joint TPMI indication or separate TPMI indication can be used to indicate one of the 13 precoders in 8TX rank 7 codebook, i.e., indicate one of possible combinations of (A₁,A₂).

Joint TPMI indication for 8TX rank 7 codebook can be defined as in Table 7:

TABLE 7

| | |
|---|---|
| TPMI | W⁷ = (A₁, A₂) (ordered from |
| index | left to right in increasing order of TPMI index) |

| | | | | |
|---|---|---|---|---|
| 0-3 | (0, 0) | (1, 1) | (1, 2) | (2, 1) |
| 4-7 | (2, 2) | (3, 3) | (3, 4) | (4, 3) |
| 8-11 | (4, 4) | (5, 3) | (5, 4) | (6, 3) |
| 12 | (6, 4) | — | — | — |

In Table 7, each TPMI index indicates a possible combination of (A₁, A₂)∈

$${W}^{7} = ( ( {G}_{1}^{3} , {G}_{1}^{4} ) ⋃ ( {G}_{2}^{3} , {G}_{2}^{4} ) ⋃ ( {G}_{3}^{3} , {G}_{3}^{4} ) ) .$$

For example, the index of A₁ is in increasing order; and for the same index of A₁, the index of A₂ is in increasing order. That is, the possible combination of (A₁,A₂) is:

$$( {G}_{1}^{3} , {G}_{1}^{4} )$$

(that is, (0,0)),

$$( {G}_{2}^{3} , {G}_{2}^{4} )$$

(that is, (1,1), (1,2), (2,1), (2,2)),

$$( {G}_{3}^{3} , {G}_{3}^{4} )$$

(that is, (3,3), (3,4), (4,3), (4,4), (5,3), (5,4), (6,3), (6,4)).

According to the joint TPMI indication, ┌log₂(13)┐(=4) bits are necessary for the TPMI field to indicate one of the 13 precoders in 8TX rank 7 codebook.

For separate TPMI indication, A₁ and A₂ can be separately indicated. That is, rank 7 TPMI can be divided into two parts TMPI1 and TMPI2, where TPMI1 (index from 0 to 6) indicates a precoder A₁ contained in G³, and TPMI2 (index from 0 up to 1) indicates A₂ from the group

$${G}_{t}^{4}$$

(t=1 or 2 or 3) that has the same type as A₁. That is, when A₁ is in

$${G}_{1}^{3} ,$$

index 0 of A₂ indicates

$${G}_{1}^{4} = \{ TPMI 0 \}$$

in 4TX rank 4 codebook; when A₁ is in

$${G}_{2}^{3} ,$$

index 0-1 of A₂ indicates

$${G}_{2}^{4} = \{ TPMI 1 - 2 \}$$

in 4TX rank 4 codebook; when A₁ is in

$${G}_{3}^{3} ,$$

index 0-1 of A₂ indicates

$${G}_{3}^{4} = \{ TPMI 3 - 4 \}$$

in 4TX rank 4 codebook.

For example, {TPMI1=1, TPMI2=1} indicates

$${A}_{1} = \frac{1}{2} [ \begin{matrix}1 & 0 & 0 \\ 0 & 1 & 0 \\ 1 & 0 & 0 \\ 0 & 0 & 1\end{matrix} ] , {A}_{2} = \frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ] ,$$

in which TPMI1-1 indicates

$${A}_{1} = \frac{1}{2} [ \begin{matrix}1 & 0 & 0 \\ 0 & 1 & 0 \\ 1 & 0 & 0 \\ 0 & 0 & 1\end{matrix} ]$$

in G³ (see Table 6.3.1.5-6), which is in group

$${G}_{2}^{3}$$

(type #2), TPMI2=1 indicates index 1 in group

$${G}_{2}^{4}$$

(type #2),

$${A}_{2} = \frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ] ,$$

which is index 2 in G⁴ (see Table 6.3.1.5-7).

According to the separate TPMI indication, ┌log₂(7)┐ (for TPMI1)+┌log₂(2)┐ (for TPMI2)=3+1=4 bits are necessary for the TPMI field to indicate one of the 13 precoders in 8TX rank 5 codebook.

When A₁ and A₂ are determined, either based on joint TPMI indication or separate TPMI indication, a 8TX rank 7

$$prccodcr = \frac{1}{\sqrt{2}} [ \begin{matrix}{A}_{1} & 0 \\ 0 & {A}_{2}\end{matrix} ]$$

is constructed from A₁ and A₂. For example, if

$${A}_{1} = \frac{1}{2} [ \begin{matrix}1 & 0 & 0 \\ 0 & 1 & 0 \\ 1 & 0 & 0 \\ 0 & 0 & 1\end{matrix} ] , {A}_{2} = \frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ] , then$$

$${W}^{7} = \frac{1}{4} [ \begin{matrix}\sqrt{2} & 0 & 0 & 0 & 0 & 0 & 0 \\ 0 & \sqrt{2} & 0 & 0 & 0 & 0 & 0 \\ \sqrt{2} & 0 & 0 & 0 & 0 & 0 & 0 \\ 0 & 0 & \sqrt{2} & 0 & 0 & 0 & 0 \\ 0 & 0 & 0 & 1 & 1 & 0 & 0 \\ 0 & 0 & 0 & 0 & 0 & 1 & 1 \\ 0 & 0 & 0 & j & - j & 0 & 0 \\ 0 & 0 & 0 & 0 & 0 & j & - j\end{matrix} ]$$

A seventh embodiment relates 8TX rank 8 precoders.

With eight layers, a first layer, a second layer, a third layer and a fourth layer are transmitted from the first antenna group, and a fifth layer, a sixth layer, a seventh layer and an eighth layer are transmitted from the second antenna group. The 8TX rank 8 precoder (i.e., 8×8 precoder or precoding matrix) takes the form

$${W}^{8} = \frac{1}{\sqrt{2}} [ \begin{matrix}{A}_{1} & 0 \\ 0 & {A}_{2}\end{matrix} ] ,$$

where, W⁸ represents 8TX rank 8 precoders (i.e., 8TX rank 8 codebook), A₁ is a 4TX rank 4 precoder (or precoding matrix) from G⁴, i.e., A₁∈G⁴, and A₂ is a 4TX rank 4 precoder (or precoding matrix) from the same group

$$( i . e . , {G}_{1}^{4} , {G}_{2}^{4} or {G}_{3}^{4} )$$

(that has the same type) as A₁. It means that only precoders from the following combinations are allowed: (A₁, A₂)∈

$${W}^{8} = ( ( {G}_{1}^{4} , {G}_{1}^{4} ) ⋃ ( {G}_{2}^{4} , {G}_{∠}^{4} ) ⋃ ( {G}_{3}^{4} , {G}_{3}^{4} ) ) ,$$

where each of

$${G}_{t}^{4}$$

represents a group of precoders in type t in 4TX rank 4 codebook.

As described in Table 1,

$${G}_{1}^{4} = \{ TPMI 0 \}$$

in 4TX rank 4 codebook has one (1) element;

$${G}_{2}^{4} = \{ TPMI 1 - 2 \}$$

in 4TX rank 4 codebook has two (2) elements; and

$${G}_{3}^{4} = \{ TPMI 3 - 4 \}$$

in 4TX rank 4 codebook has two (2) elements. The total number of states (A₁,A₂) in

$${W}^{8} = ( ( {G}_{1}^{4} , {G}_{1}^{4} ) ⋃ ( {G}_{2}^{4} , {G}_{2}^{4} ) ⋃ ( {G}_{3}^{4} , {G}_{3}^{4} ) )$$

is=1×1+2×2+2×2=1+4+4=9.

Joint TPMI indication or separate TPMI indication can be used to indicate one of the 9 precoders in 8TX rank 8 codebook, i.e., indicate one of possible combinations of (A₁,A₂).

Joint TPMI indication for 8TX rank 8 codebook can be defined as in Table 8:

TABLE 8

| | |
|---|---|
| TPMI | W⁸ = (A₁, A₂) (ordered from |
| index | left to right in increasing order of TPMI index) |

| | | | | |
|---|---|---|---|---|
| 0-3 | (0, 0) | (1, 1) | (1, 2) | (2, 1) |
| 4-7 | (2, 2) | (3, 3) | (3, 4) | (4, 3) |
| 8 | (4, 4) | — | — | — |

In Table 8, each TPMI index indicates a possible combination of (A₁, A₂)∈

$${W}^{8} = ( ( {G}_{1}^{4} , {G}_{1}^{4} ) ⋃ ( {G}_{2}^{4} , {G}_{2}^{4} ) ⋃ ( {G}_{3}^{4} , {G}_{3}^{4} ) ) .$$

For example, the index of A₁ is in increasing order; and for the same index of A₁, the index of A₂ is in increasing order. That is, the possible combination of (A₁, A₂) is:

$$( {G}_{1}^{4} , {G}_{1}^{4} )$$

(that is, (0,0)),

$$( {G}_{2}^{4} , {G}_{2}^{4} )$$

(that is, (1,1), (1,2), (2,1), (2,2)) and

$$( {G}_{3}^{4} , {G}_{3}^{4} )$$

(that is, (3,3), (3,4), (4,3), (4,4)).

According to the joint TPMI indication, ┌log₂(9)┐(=4) bits are necessary for the TPMI field to indicate one of the 9 precoders in 8TX rank 8 codebook.

For separate TPMI indication, A₁ and A₂ can be separately indicated. That is, rank 8 TPMI can be divided into two parts TMPI1 and TMPI2, where TPMI1 (index from 0 to 4) indicates a precoder A₁ contained in G⁴, and TPMI2 (index from 0 up to 1) indicates A₂ from the same group

$${G}_{t}^{4}$$

(t=1 or 2 or 3) as A₁. That is, when A₁ is in

$${G}_{1}^{4} ,$$

index 0 of A₂ indicates

$${G}_{1}^{4} = \{ TPMI 0 \}$$

in 4TX rank 4 codebook; when A₁ is in

$${G}_{2}^{4} ,$$

index 0-1 of A₂ indicates

$${G}_{2}^{4} = \{ TPMI 1 - 2 \}$$

in 4TX rank 4 codebook; when A₁ is in

$${G}_{3}^{4} ,$$

index 0-1 of A₂ indicates

$${G}_{3}^{4} = \{ TPMI 3 - 4 \}$$

in 4TX rank 4 codebook.

For example, {TPMI1=1, TPMI2=1} indicates

$${A}_{1} = \frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ] , {A}_{2} = \frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ] ,$$

in which TPMI1=1 indicates

$${A}_{1} = \frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$$

in G⁴ (see Table 6.3.1.5-7), which is group

$${G}_{2}^{4}$$

(type #2), TPMI2=1 indicates index 1 in group

$${G}_{2}^{4}$$

(type #2)

$$( {A}_{2} = \frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ] ) ,$$

which is index 2 in G⁴ (see Table 6.3.1.5-7).

According to the separate TPMI indication, ┌log₂(5)┐ (for TPMI1)+┌log₂(2)┐ (for TPMI2) 3+1 4 bits are necessary for the TPMI field to indicate one of the 9 precoders in 8TX rank 8 codebook.

When A₁ and A₂ are determined, either based on joint TPMI indication or separate TPMI indication, a 8TX rank

$$precoder = \frac{1}{\sqrt{2}} [ \begin{matrix}{A}_{1} & 0 \\ 0 & {A}_{2}\end{matrix} ]$$

is constructed from A₁ and A₂. For example, if

$${A}_{1} = \frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ] , {A}_{2} = \frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ] , then$$

$${W}^{8} = \frac{1}{4} [ \begin{matrix}1 & 1 & 0 & 0 & 0 & 0 & 0 & 0 \\ 0 & 0 & 1 & 1 & 0 & 0 & 0 & 0 \\ 1 & - 1 & 0 & 0 & 0 & 0 & 0 & 0 \\ 0 & 0 & 1 & - 1 & 0 & 0 & 0 & 0 \\ 0 & 0 & 0 & 0 & 1 & 1 & 0 & 0 \\ 0 & 0 & 0 & 0 & 0 & 0 & 1 & 1 \\ 0 & 0 & 0 & 0 & j & - j & 0 & 0 \\ 0 & 0 & 0 & 0 & 0 & 0 & j & - j\end{matrix} ] .$$

Table 9 summarizes the number of precoders according to this disclosure in 8TX codebook for each of ranks 2 to 8, as well as the number of bits necessary for joint TPMI indication and the number of bits necessary for separate TPMI indication.

TABLE 9

| | number of | number of bits | number of bits |
|---|---|---|---|
| | precoders in | necessary for joint | necessary for separate |
| | codebook | TPMI indication | TPMI indication |
| Rank 2 | 336 | 9 | 5 + 4 = 9 |
| Rank 3 | 216 | 8 | 5 + 3 = 8 |
| Rank 4 | 164 | 8 | 5 + 3 = 8 |
| Rank 5 | 54 | 6 | 5 + 2 = 7 |
| Rank 6 | 21 | 5 | 3 + 2 = 5 |
| Rank 7 | 13 | 4 | 3 + 1 = 1 |
| Rank 8 | 9 | 4 | 3 + 1 = 4 |

If the two 4TX precoders can be selected without considering the type of the 4TX precoders, the number of precoders in 8TX codebook will be much larger than the number of precodersin 8TX codebook proposed in this disclosure as compared in Table 10.

TABLE 10

| | | number of precoders | number of bits |
|---|---|---|---|
| | | in codebook | necessary for joint |
| | number of | without | TPMI indication |
| | precoders | considering | without considering |
| | in codebook | the type | the type |
| Rank 2 | 336 | 28*28 = 781 | 10 |
| Rank 3 | 216 | 28*22 = 616 | 10 |
| Rank 4 | 164 | 22*22 = 484 | 9 |
| Rank 5 | 54 | 22*7 = 154 | 8 |
| Rank 6 | 21 | 7*7 = 49 | 6 |
| Rank 7 | 13 | 7*5 = 35 | 6 |
| Rank 8 | 9 | 5*5 = 25 | 5 |

According to an eighth embodiment, the joint TPMI indication or the separate TPMI indication described in the first embodiment to the seventh embodiment can be implemented in the TPMI that is included in the TPMI field. The TPMI field can be used in DCI format 0_1 or 0_2 to schedule dynamically scheduled PUSCH or type 2 configured-grant PUSCH, or in RRC message (configuredGrantConfig) to configure type 1 configured-grant PUSCH.

The above embodiments assumes that the transmission from the UE to the TRP can be represented as:

$$Y = HWX + N = [ {H}_{1} {H}_{2} ] [ \begin{matrix}{W}_{1} & 0 \\ 0 & {W}_{2}\end{matrix} ] [ \begin{matrix}{X}_{1} \\ {X}_{2}\end{matrix} ] + N = {H}_{1} {W}_{1} {X}_{1} + {H}_{2} {W}_{2} {X}_{2} + N .$$

In the following embodiments, the transmission from the UE to the TRP can be represented as:

$$Y = HWPX + N = [ {H}_{1} {H}_{2} ] [ \begin{matrix}{W}_{1} & 0 \\ 0 & {W}_{2}\end{matrix} ] [ \begin{matrix}\sqrt{{P}_{1}} & 0 \\ 0 & \sqrt{{P}_{2}}\end{matrix} ] [ \begin{matrix}{X}_{1} \\ {X}_{2}\end{matrix} ] + N = {H}_{1} {W}_{1} \sqrt{{P}_{1}} {X}_{1} + {H}_{2} {W}_{2} \sqrt{{P}_{2}} {X}_{2} + N ,$$

where Hᵢ, Wᵢ, Xᵢ, P are the channel, precoding matrix, and information and transmission power from the antenna group i (i is 1 or 2) to the TRP respectively, and N is the receiver noise vector. It can be seen that the power (P) is further considered.

As described above, H₁ and H₂ are correlated, where their correlation depends on the ratio of strength of different multi-paths between the UE and the TRP. When the channel is dominated by a strong singular path, such as a LOS channel or with a Rician channel with large K factor, the two channels are highly correlated or even identical subject to a phase shift: H₂=e^{jφ}H₁. This leads us to believe the best individual precoders for each antenna group in the absence of the other group are also strongly correlated. For highly correlated channel, these precoders of the same rank are also highly correlated or even identical. This gives us the idea of using the same or very similar precoding matrices in the two antenna groups for transmission.

It is proposed that among the 8 antenna ports, the first four antenna ports (e.g., antenna ports 0, 1, 2, 3) belong to a first antenna group and the last four antenna ports (e.g., antenna ports 4, 5, 6, 7) belong to a second antenna group. The first antenna group and the second antenna group are non-coherent.

In the following disclosure, one precoding matrix (i.e., precode) A in NR Release 15 4TX codebook is used to construct a 8TX codebook W with one of the three forms:

$${W}_{1} = \frac{1}{\sqrt{2}} [ \begin{matrix}A \\ 0\end{matrix} ] or {W}_{2} = \frac{1}{\sqrt{2}} [ \begin{matrix}0 \\ A\end{matrix} ] or {W}_{3} = \frac{1}{\sqrt{2}} [ \begin{matrix}A \\ A\end{matrix} ] ,$$

where A and W (W₁, W₂ or W₃) have the same rank (i.e., the number of layers). It implies that only ranks 1 to 4 are supported.

$${W}_{1} = \frac{1}{\sqrt{2}} [ \begin{matrix}A \\ 0\end{matrix} ]$$

implies that only the first antenna group is used for data transmission and the second antenna group is not used.

$${W}_{2} = \frac{1}{\sqrt{2}} [ \begin{matrix}0 \\ A\end{matrix} ]$$

implies that only the second antenna group is used for data transmission and the first antenna group is not used.

$${W}_{3} = \frac{1}{\sqrt{2}} [ \begin{matrix}A \\ A\end{matrix} ]$$

implies that both the first antenna group and the second antenna group are used for data transmission.

It is assumed that each antenna port (i.e., each of 8 antenna ports) is equipped with a PA with maximal power

$$\frac{{P}_{max}}{8} .$$

For a Class 3 UE with Pₘₐₓ=23 dBm, each PA has power rating of 14 dBm. When the limited PAs at the antennas can transmit with the required transmission power without power reduction, it is better to concentrate on the power from a single group of coherent antennas. It means that

$${W}_{1} = \frac{1}{\sqrt{2}} [ \begin{matrix}A \\ 0\end{matrix} ] or {W}_{2} = \frac{1}{\sqrt{2}} [ \begin{matrix}0 \\ A\end{matrix} ]$$

can be selected. The reason why both

$${W}_{1} = \frac{1}{\sqrt{2}} [ \begin{matrix}A \\ 0\end{matrix} ] and {W}_{2} = \frac{1}{\sqrt{2}} [ \begin{matrix}0 \\ A\end{matrix} ]$$

are included in the codebook is to allow antenna group selection. On the other hand, when the PAs at the antenna ports reach their limit, it is better to transmit with the precoder

$${W}_{3} = \frac{1}{\sqrt{2}} [ \begin{matrix}A \\ A\end{matrix} ]$$

to allow more antenna ports (and more PAs) to transmit to increase the UL coverage. This is especially useful for the UE located at cell edge.

The following embodiments (a ninth embodiment, a tenth embodiment, an eleventh embodiment and a twelfth embodiment) relate to 8TX rank 1 to 4 precoders.

The ninth embodiment relates to 8TX Rank 1 precoders.

For each 8TX Rank 1 precoder, a matrix A is selected from Table 6.3.1.5-2 (for DFT-s-OFDM) or Table 6.3.1.5-3 (for CP-OFDM) specified in 3GPP Technical Specification TS38.211 V16.0.0. The 8TX Rank 1 precoders (i.e., the 8×1 precoders or precoding matrices) can be

$${W}_{1}^{1} ( A ) = \frac{1}{\sqrt{2}} [ \begin{matrix}A \\ 0\end{matrix} ] , {W}_{2}^{1} ( A ) = \frac{1}{\sqrt{2}} [ \begin{matrix}0 \\ A\end{matrix} ] , or {W}_{3}^{1} ( A ) = \frac{1}{\sqrt{2}} [ \begin{matrix}A \\ A\end{matrix} ] .$$

It can be seen that

$${W}_{1}^{1} ( A ) and {W}_{2}^{1} ( A )$$

provide antenna group selection on top of coherent transmission with up to 4 antenna ports within one antenna group, and allow UE to transmit with higher power. Note that as shown above, when transmitting with

$${W}_{3}^{1} ( A ) = \frac{1}{\sqrt{2}} [ \begin{matrix}A \\ A\end{matrix} ] ,$$

even with twice the number of antenna ports transmitting and the total transmission power being doubled, the received SNR increases only by 3 dB instead of 6 dB since the two antenna groups are non-coherent and are subject to random phase shift. This is the penalty paid for transmitting with non-coherent antenna groups.

Since there are different (e.g., 28) matrices A in Table 6.3.1.5-2 (for DFT-s-OFDM) or Table 6.3.1.5-3 (for CP-OFDM), the total number of 8TX Rank 1 precoders constructed from the matrix A is 3×28=84. This requires ┌log₂(84)┐(=7) bits necessary for the TPMI to indicate one of 84 8TX rank 1 precoders. A 8TX rank 1 codebook can be constructed as follows in Table 11.

TABLE 11

| | W | | | | | | | |
|---|---|---|---|---|---|---|---|---|
| TPMI index | (ordered from left to right in increasing order of TPMI index) | | | | | | | |
| 0-7 | $\frac{1}{2 \sqrt{2}} [ \begin{matrix}1 \\ 0 \\ 0 \\ 0 \\ 0 \\ 0 \\ 0 \\ 0\end{matrix} ]$ | $\frac{1}{2 \sqrt{2}} [ \begin{matrix}0 \\ 0 \\ 0 \\ 0 \\ 1 \\ 0 \\ 0 \\ 0\end{matrix} ]$ | $\frac{1}{2 \sqrt{2}} [ \begin{matrix}1 \\ 0 \\ 0 \\ 0 \\ 1 \\ 0 \\ 0 \\ 0\end{matrix} ]$ | $\frac{1}{2 \sqrt{2}} [ \begin{matrix}0 \\ 1 \\ 0 \\ 0 \\ 0 \\ 0 \\ 0 \\ 0\end{matrix} ]$ | $\frac{1}{2 \sqrt{2}} [ \begin{matrix}0 \\ 0 \\ 0 \\ 0 \\ 0 \\ 1 \\ 0 \\ 0\end{matrix} ]$ | $\frac{1}{2 \sqrt{2}} [ \begin{matrix}0 \\ 1 \\ 0 \\ 0 \\ 0 \\ 1 \\ 0 \\ 0\end{matrix} ]$ | $\frac{1}{2 \sqrt{2}} [ \begin{matrix}0 \\ 0 \\ 1 \\ 0 \\ 0 \\ 0 \\ 0 \\ 0\end{matrix} ]$ | $\frac{1}{2 \sqrt{2}} [ \begin{matrix}0 \\ 0 \\ 0 \\ 0 \\ 0 \\ 0 \\ 1 \\ 0\end{matrix} ]$ |
| ... | ... | ... | ... | ... | ... | ... | ... | ... |
| 80-83 | $\frac{1}{2 \sqrt{2}} [ \begin{matrix}1 \\ - j \\ - 1 \\ j \\ 1 \\ - j \\ - 1 \\ j\end{matrix} ]$ | $\frac{1}{2 \sqrt{2}} [ \begin{matrix}1 \\ - j \\ - j \\ - 1 \\ 0 \\ 0 \\ 0 \\ 0\end{matrix} ]$ | $\frac{1}{2 \sqrt{2}} [ \begin{matrix}0 \\ 0 \\ 0 \\ 0 \\ 1 \\ - j \\ - j \\ - 1\end{matrix} ]$ | $\frac{1}{2 \sqrt{2}} [ \begin{matrix}1 \\ - j \\ - j \\ - 1 \\ 1 \\ - j \\ - j \\ - 1\end{matrix} ]$ | — | — | — | — |

In Table 11, each TPMI index indicates one of

$${W}_{1}^{1} ( {A}_{( x )} ) , {W}_{2}^{1} ( {A}_{( x )} ) and {W}_{3}^{1} ( {A}_{( x )} ) ,$$

where x is the index 0 to 27 in Table 6.3.1.5-2 (for DFT-s-OFDM) or Table 6.3.1.5-3 (for CP-OFDM). For example, TPMI index y indicates

$${W}_{( y mod 3 ) + 1}^{1} ( {A}_{( ⌊ y / 3 ⌋} ) .$$

In particular, TPMI index 0 indicates

$${W}_{1}^{1} ( {A}_{( 0 )} ) = \frac{1}{\sqrt{2}} [ \begin{matrix}A \\ 0\end{matrix} ] , where A = \frac{1}{2} [ \begin{matrix}1 \\ 0 \\ 0 \\ 0\end{matrix} ] ,$$

TPMI index 1 indicates

$${W}_{2}^{1} ( {A}_{( 0 )} ) ,$$

TPMI index 2 indicates

$${W}_{3}^{1} ( {A}_{( 0 )} ) ,$$

TPMI index 3 indicates

$${W}_{1}^{1} ( {A}_{( 1 )} ) ,$$

. . . etc.

It can be seen that not all the precoders of the form

$${W}_{3}^{1} ( A )$$

in Table 11 allows full power transmission. It means that only

$${W}_{3}^{1} ( A )$$

constructed by entries {12-27} (i.e., precoding matrices with all antenna ports active) in Table 6.3.1.5-2 or 6.3.1.5-3 enables to transmit with all 8 antenna ports. In view of the above, it is possible that only

$${W}_{3}^{1} ( A )$$

constructed by entries {12-27} in Table 6.3.1.5-2 or 6.3.1.5-3 is included in Table 11, together with

$${W}_{1}^{1} ( A ) and {W}_{2}^{1} ( A )$$

with all the entries of A from Table 6.3.1.5-2 or 6.3.1.5-3. It would result a total of 8TX Rank 1 precoders 28+28+16=72, that requires ┌log₂(72)┐(=7) bits necessary for the TPMI indication.

If the number of bits necessary for the TPMI indication are reduced to 6, which implies a total of 8TX Rank 1 precoders being 64 (=2⁶). So, only

$${W}_{3}^{1} ( A )$$

constructed by eight entries, e.g., entries {12-19}, in Table 6.3.1.5-2 or 6.3.1.5-3 may be included in Table 11, together with

$${W}_{1}^{1} ( A ) and {W}_{2}^{1} ( A )$$

with all the entries of A from Table 6.3.1.5-2 or 6.3.1.5-3.

The tenth embodiment relates to 8TX Rank 2 precoders.

For 8TX Rank 2 precoder, a matrix A is selected from Table 6.3.1.5-5 specified in 3GPP Technical Specification TS38.211 V16.0.0. The 8TX Rank 2 precoders (i.e., the 8×2 precoders or precoding matrices) can be

$${W}_{1}^{2} ( A ) = \frac{1}{\sqrt{2}} [ \begin{matrix}A \\ 0\end{matrix} ] , {W}_{2}^{2} ( A ) = \frac{1}{\sqrt{2}} [ \begin{matrix}0 \\ A\end{matrix} ] , {W}_{3}^{2} ( A ) = \frac{1}{\sqrt{2}} [ \begin{matrix}A \\ A\end{matrix} ] .$$

Since there are different (e.g., 22) matrices A in Table 6.3.1.5-5, the total number of 8TX Rank 2 precoders constructed from the matrix A is 3×22=66. This requires ┌log₂(66)┐(=7) bits necessary for the TPMI to indicate one of 66 8TX rank 2 precoders. A 8TX rank 2 codebook can be constructed as follows in Table 12.

TABLE 12

| | W | | | |
|---|---|---|---|---|
| TPMI index | (ordered from left to right in increasing order of TPMI index) | | | |
| 0-3 | $\frac{1}{2 \sqrt{2}} [ \begin{matrix}1 & 0 \\ 0 & 1 \\ 0 & 0 \\ 0 & 0 \\ 0 & 0 \\ 0 & 0 \\ 0 & 0 \\ 0 & 0\end{matrix} ]$ | $\frac{1}{2 \sqrt{2}} [ \begin{matrix}0 & 0 \\ 0 & 0 \\ 0 & 0 \\ 0 & 0 \\ 1 & 0 \\ 0 & 1 \\ 0 & 0 \\ 0 & 0\end{matrix} ]$ | $\frac{1}{2 \sqrt{2}} [ \begin{matrix}1 & 0 \\ 0 & 1 \\ 0 & 0 \\ 0 & 0 \\ 1 & 0 \\ 0 & 1 \\ 0 & 0 \\ 0 & 0\end{matrix} ]$ | $\frac{1}{2 \sqrt{2}} [ \begin{matrix}1 & 0 \\ 0 & 0 \\ 0 & 1 \\ 0 & 0 \\ 1 & 0 \\ 0 & 0 \\ 0 & 1 \\ 0 & 0\end{matrix} ]$ |
| ... | ... | ... | ... | ... |
| 64-65 | $\frac{1}{4} [ \begin{matrix}0 & 0 \\ 0 & 0 \\ 0 & 0 \\ 0 & 0 \\ 1 & 1 \\ - j & - j \\ j & - j \\ 1 & - 1\end{matrix} ]$ | $\frac{1}{4} [ \begin{matrix}1 & 1 \\ - j & - j \\ j & - j \\ 1 & - 1 \\ 1 & 1 \\ - j & - j \\ j & - j \\ 1 & - 1\end{matrix} ]$ | — | — |

In Table 12, each TPMI index indicates one of

$${W}_{1}^{2} ( {A}_{( x )} ) , {W}_{2}^{2} ( {A}_{( x )} ) , and {W}_{3}^{2} ( {A}_{( x )} ) ,$$

where x is the index 0 to 21 in Table 6.3.1.5-5. For example, TPMI index y indicates

$${W}_{( y mod 3 ) + 1}^{2} ( {A}_{( ⌊ y / 3 ⌋ )} ) .$$

It can be seen that not all the precoders of the form

$${W}_{3}^{2} ( A )$$

in Table 12 allows full power transmission. It means that only

$${W}_{3}^{2} ( A )$$

constructed by entries {6-21} (i.e., precoding matrices with all antenna ports active) in Table 6.3.1.5-5 enables UE to transmit with all 8 antenna ports. In view of the above, it is possible that only

$${W}_{3}^{2} ( A )$$

constructed by entries {6-21} in Table 6.3.1.5-5 is included in Table 12, together with

$${W}_{1}^{2} ( A ) and {W}_{2}^{2} ( A )$$

with all the entries of A from Table 6.3.1.5-5. It would result a total of 8TX Rank 2 precoders 22+22+16=60, that requires ┌log₂(60)┐(=6) bits necessary for the TPMI indication.

In addition, it is possible that only

$${W}_{3}^{2} ( A )$$

constructed by entries {6, 10, 14, 16, 19, 20} (or its subset) in Table 6.3.1.5-5 may be included in Table 12, together with

$${W}_{1}^{2} ( A ) and {W}_{2}^{2} ( A )$$

with all the entries of A from Table 6.3.1.5-5. This will further reduce the size of the 8TX Rank 2 codebook to 50, although ┌log₂(50)┐(=6) bits are still necessary for the TPMI indication.

The eleventh embodiment relates to 8TX Rank 3 precoders.

For 8TX Rank 3 precoder, a matrix A is selected from Table 6.3.1.5-6 specified in 3GPP Technical Specification TS38.211 V16.0.0. The 8TX Rank 3 precoders (i.e., the 8×3 precoders or precoding matrices) can be

$${W}_{1}^{3} ( A ) = \frac{1}{\sqrt{2}} [ \begin{matrix}A \\ 0\end{matrix} ] , {W}_{2}^{3} ( A ) = \frac{1}{\sqrt{2}} [ \begin{matrix}0 \\ A\end{matrix} ] or {W}_{3}^{3} ( A ) = \frac{1}{\sqrt{2}} [ \begin{matrix}A \\ A\end{matrix} ] .$$

Since there are different (e.g., 7) matrices A in Table 6.3.1.5-6, the total number of 8TX Rank 3 precoders constructed from the matrix A is 3×7=21. This requires ┌log₂(21)┐(=5) bits necessary for the TPMI to indicate one of 21 8TX rank 3 precoders. A 8TX rank 3 codebook can be constructed as follows in Table 13.

TABLE 13

| TPMI | W | | | |
|---|---|---|---|---|
| index | (ordered from left to right in increasing order of TPMI index) | | | |
| 0-3 | $\frac{1}{2 \sqrt{2}} [ \begin{matrix}1 & 0 & 0 \\ 0 & 1 & 0 \\ 0 & 0 & 1 \\ 0 & 0 & 0 \\ 0 & 0 & 0 \\ 0 & 0 & 0 \\ 0 & 0 & 0 \\ 0 & 0 & 0\end{matrix} ]$ | $\frac{1}{2 \sqrt{2}} [ \begin{matrix}0 & 0 & 0 \\ 0 & 0 & 0 \\ 0 & 0 & 0 \\ 0 & 0 & 0 \\ 1 & 0 & 0 \\ 0 & 1 & 0 \\ 0 & 0 & 1 \\ 0 & 0 & 0\end{matrix} ]$ | $\frac{1}{2 \sqrt{2}} [ \begin{matrix}1 & 0 & 0 \\ 0 & 1 & 0 \\ 0 & 0 & 1 \\ 0 & 0 & 0 \\ 1 & 0 & 0 \\ 0 & 1 & 0 \\ 0 & 0 & 1 \\ 0 & 0 & 0\end{matrix} ]$ | $\frac{1}{2 \sqrt{2}} [ \begin{matrix}1 & 0 & 0 \\ 0 & 1 & 0 \\ 1 & 0 & 0 \\ 0 & 0 & 1 \\ 0 & 0 & 0 \\ 0 & 0 & 0 \\ 0 & 0 & 0 \\ 0 & 0 & 0\end{matrix} ]$ |
| ... | ... | ... | ... | ... |
| 20 | $\frac{1}{2 \sqrt{6}} [ \begin{matrix}1 & 1 & 1 \\ - 1 & 1 & - 1 \\ j & j & - j \\ - j & j & j \\ 1 & 1 & 1 \\ - 1 & 1 & - 1 \\ j & j & - j \\ - j & j & j\end{matrix} ]$ | — | — | — |

In Table 13, each TPMI index indicates one of

$${W}_{1}^{3} ( {A}_{( x )} ) , {W}_{2}^{3} ( {A}_{( x )} ) , and {W}_{3}^{3} ( {A}_{( x )} ) ,$$

where x is index 0 to 6 in Table 6.3.1.5-6. For example, TPMI index y indicates

$${W}_{( y mod 3 ) + 1}^{3} ( {A}_{( ⌊ y / 3 ⌋ )} ) .$$

It can be seen that not all the precoders of the form

$${W}_{3}^{3} ( A )$$

in Table 13 allows full power transmission. It means that only

$${W}_{3}^{3} ( A )$$

constructed by entries {1-6}(i.e., precoding matrices with all antenna ports active) in Table 6.3.1.5-6 enables UE to transmit with all 8 antenna ports. In view of the above, it is possible that only

$${W}_{3}^{3} ( A )$$

constructed by entries {1-6} in Table 6.3.1.5-6 is included in Table 13, together with

$${W}_{1}^{3} ( A ) and {W}_{2}^{3} ( A )$$

with all the entries of A from Table 6.3.1.5-6. It would result a total of 8TX Rank 3 precoders 7+7+6 20, that requires ┌log₂(20)┐(=5) bits necessary for the TPMI indication.

In addition, it is possible that only

$${W}_{3}^{3} ( A )$$

constructed by entries {1, 3} or entries {1, 4} in Table 6.3.1.5-6 may be included in Table 13, together with

$${W}_{1}^{3} ( A ) and {W}_{2}^{3} ( A )$$

with all the entries of A from Table 6.3.1.5-6. This will further reduce the size of the 8TX Rank 3 codebook to 16, that requires ┌log₂(16)┐(=4) bits necessary for the TPMI indication.

The twelfth embodiment relates to 8TX Rank 4 precoders.

For 8TX Rank 4 precoder, a matrix A is selected from Table 6.3.1.5-7 specified in 3GPP Technical Specification TS38.211 V16.0.0. The 8TX Rank 4 precoders (i.e., the 8×4 precoders or precoding matrices) can be

$${W}_{1}^{4} ( A ) = \frac{1}{\sqrt{2}} [ \begin{matrix}A \\ 0\end{matrix} ] , {W}_{2}^{4} ( A ) = \frac{1}{\sqrt{2}} [ \begin{matrix}0 \\ A\end{matrix} ] or {W}_{3}^{4} ( A ) = \frac{1}{\sqrt{2}} [ \begin{matrix}A \\ A\end{matrix} ] .$$

Since there are different (e.g., 5) matrices A in Table 6.3.1.5-7, the total number of 8TX Rank 4 precoders constructed from the matrix A is 3×5=15. This requires ┌log₂(15)┐(=4) bits necessary for the TPMI to indicate one of 15 8TX rank 4 precoders. A 8TX rank 4 codebook can be constructed as follows in Table 14.

TABLE 14

| TPMI | W | | | |
|---|---|---|---|---|
| index | (ordered from left to right in increasing order of TPMI index) | | | |
| 0-3 | $\frac{1}{2 \sqrt{2}} [ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ]$ | $\frac{1}{2 \sqrt{2}} [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 0 & 0 & 0 \\ 0 & 1 & 0 & 0 \\ 0 & 0 & 1 & 0 \\ 0 & 0 & 0 & 1 \\ 1 & 0 & 0 & 0 \\ 0 & 1 & 0 & 0 \\ 0 & 0 & 1 & 0 \\ 0 & 0 & 0 & 1\end{matrix} ]$ | $\frac{1}{4} [ \begin{matrix}1 & 1 & 0 & 0 \\ 0 & 0 & 1 & 1 \\ 1 & - 1 & 0 & 0 \\ 0 & 0 & 1 & - 1 \\ 0 & 0 & 0 & 0 \\ 0 & 0 & 0 & 0 \\ 0 & 0 & 0 & 0 \\ 0 & 0 & 0 & 0\end{matrix} ]$ |
| ... | ... | ... | ... | ... |
| 12-14 | $\frac{1}{4 \sqrt{2}} [ \begin{matrix}1 & 1 & 1 & 1 \\ 1 & - 1 & 1 & - 1 \\ j & j & - j & - j \\ j & - j & - j & j \\ 0 & 0 & 0 & 0 \\ 0 & 0 & 0 & 0 \\ 0 & 0 & 0 & 0 \\ 0 & 0 & 0 & 0\end{matrix} ]$ | $\frac{1}{4 \sqrt{2}} [ \begin{matrix}0 & 0 & 0 & 0 \\ 0 & 0 & 0 & 0 \\ 0 & 0 & 0 & 0 \\ 0 & 0 & 0 & 0 \\ 1 & 1 & 1 & 1 \\ 1 & - 1 & 1 & - 1 \\ j & j & - j & - j \\ j & - j & - j & j\end{matrix} ]$ | $\frac{1}{4 \sqrt{2}} [ \begin{matrix}1 & 1 & 1 & 1 \\ 1 & - 1 & 1 & - 1 \\ j & j & - j & - j \\ j & - j & - j & j \\ 1 & 1 & 1 & 1 \\ 1 & - 1 & 1 & - 1 \\ j & j & - j & - j \\ j & - j & - j & j\end{matrix} ]$ | — |

In Table 14, each TPMI index indicates one of

$${W}_{1}^{4} ( {A}_{( x )} ) , {W}_{2}^{4} ( {A}_{( x )} ) and {W}_{3}^{4} ( {A}_{( x )} ) ,$$

where x is index 0 to 4 in Table 6.3.1.5-7. For example, TPMI index y indicates

$${W}_{( y mod 3 ) + 1}^{4} ( {A}_{( ⌊ v / 3 ⌋ )} ) .$$

If it is necessary to reduce the size of the codebook, only a subset of the precoding matrices from Table 6.3.1.5-7 can be used to construct

$${W}_{3}^{4} ( A ) .$$

For example, only

$${W}_{3}^{4} ( A )$$

constructed by entries {0, 2} or entries {0, 2, 4} in Table 6.3.1.5-7 may be included in Table 14, together with

$${W}_{1}^{4} ( A ) and {W}_{2}^{4} ( A )$$

with all the entries of A from Table 6.3.1.5-7. This will further reduce the size of the 8TX Rank 4 codebook to 12 or 13, although ┌log₂(12)┐(=4) or ┌log₂(13)┐(=4) bits are still necessary for the TPMI indication.

According to a thirteenth embodiment, the TPMI indication described in the ninth embodiment to the twelfth embodiment can be implemented in the TPMI that is included in the TPMI field. The TPMI field can be used in DCI format 0_1 or 0_2 to schedule dynamically scheduled PUSCH or type 2 configured-grant PUSCH, or in RRC message (configuredGrantConfig) to configure type 1 configured-grant PUSCH.

FIG. 2 is a schematic flow chart diagram illustrating an embodiment of a method 200 according to the present application. In some embodiments, the method 200 is performed by an apparatus, such as a remote unit (e.g., UE). In certain embodiments, the method 200 may be performed by a processor executing program code, for example, a microcontroller, a microprocessor, a CPU, a GPU, an auxiliary processing unit, a FPGA, or the like.

The method 200 is a method performed at a UE, comprising: 202 receiving a control message scheduling a PUSCH transmission with transmission rank N to be transmitted by two antenna groups, wherein, the control message includes a TPMI that indicates two 4TX precoding matrices used by the two antenna groups, and the two 4TX precoding matrices are of the same type, wherein, N is any of 2 to 8; and 204 transmitting the scheduled PUSCH transmission transmitted according to the control message.

In some embodiment, the precoding matrices are classified into different types according to the number of active transmitting antenna ports and their relative phases.

In some embodiment, the TPMI indicates the two 4TX precoding matrices jointly from possible combinations of two precoding matrices.

In some embodiment, the TPMI includes a first part indicating a first precoding matrix from all possible precoding matrices of a predetermined rank and a second part indicating a second precoding matrix from a subset of possible precoding matrices determined by the first precoding matrix.

In some embodiment, if the transmission rank is 2, both 4TX precoding matrices are 4TX rank 1 precoding matrices; if the transmission rank is 3, the two 4TX precoding matrices are one 4TX rank 1 precoding matrix and one 4TX rank 2 precoding matrix; if the transmission rank is 4, both 4TX precoding matrices are 4TX rank 2 precoding matrices; if the transmission rank is 5, the two 4TX precoding matrices are one 4TX rank 2 precoding matrix and one 4TX rank 3 precoding matrix; if the transmission rank is 6, both 4TX precoding matrices are 4TX rank 3 precoding matrices; if the transmission rank is 7, the two 4TX precoding matrices are one 4TX rank 3 precoding matrix and one 4TX rank 4 precoding matrix; and if the transmission rank is 8, and both 4TX precoding matrices are 4TX rank 4 precoding matrices.

In some embodiment, the method further comprises constructing a 8TX precoder from the two 4TX precoding matrices.

In some embodiment, the control message is a DCI format 0_1 or 0_2 that schedule dynamically scheduled PUSCH or type 2 configured grant PUSCH. Alternatively, the control message is a RRC message that schedules type 1 configured grant PUSCH.

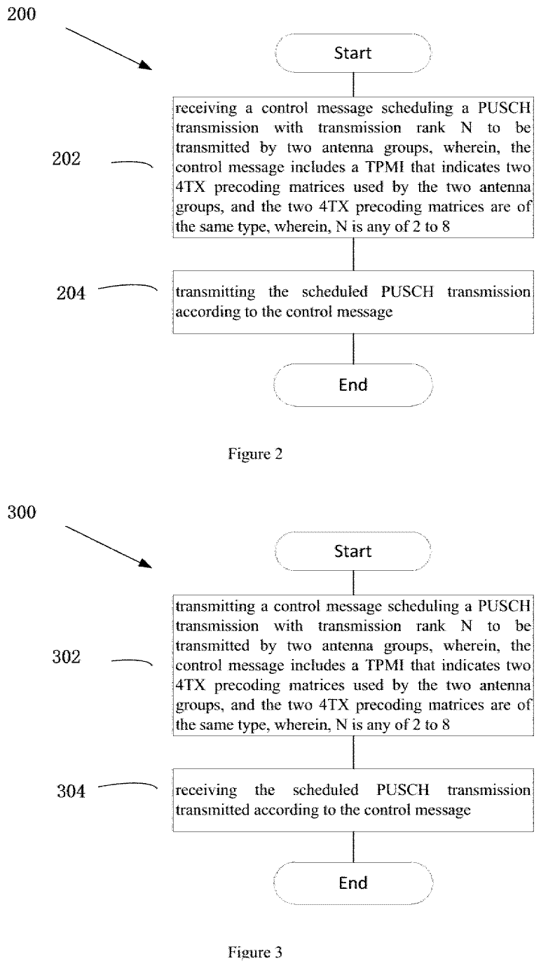

FIG. 3 is a schematic flow chart diagram illustrating an embodiment of a method 300 according to the present application. In some embodiments, the method 300 is performed by an apparatus, such as a base unit. In certain embodiments, the method 300 may be performed by a processor executing program code, for example, a microcontroller, a microprocessor, a CPU, a GPU, an auxiliary processing unit, a FPGA, or the like.

The method 300 may comprise 302 transmitting a control message scheduling a PUSCH transmission with transmission rank N to be transmitted by two antenna groups, wherein, the control message includes a TPMI that indicates two 4TX precoding matrices used by the two antenna groups, and the two 4TX precoding matrices are of the same type, wherein, N is any of 2 to 8; and 304 receiving the scheduled PUSCH transmission transmitted according to the control message.

In some embodiment, the precoding matrices are classified into different types according to the number of active transmitting antenna ports and their relative phases.

In some embodiment, the TPMI indicates the two 4TX precoding matrices jointly from possible combinations of two precoding matrices.

In some embodiment, the TPMI includes a first part indicating a first precoding matrix from all possible precoding matrices of a predetermined rank and a second part indicating a second precoding matrix from a subset of possible precoding matrices determined by the first precoding matrix.

In some embodiment, if the transmission rank is 2, both 4TX precoding matrices are 4TX rank 1 precoding matrices; if the transmission rank is 3, the two 4TX precoding matrices are one 4TX rank 1 precoding matrix and one 4TX rank 2 precoding matrix; if the transmission rank is 4, both 4TX precoding matrices are 4TX rank 2 precoding matrices; if the transmission rank is 5, the two 4TX precoding matrices are one 4TX rank 2 precoding matrix and one 4TX rank 3 precoding matrix; if the transmission rank is 6, both 4TX precoding matrices are 4TX rank 3 precoding matrices; if the transmission rank is 7, the two 4TX precoding matrices are one 4TX rank 3 precoding matrix and one 4TX rank 4 precoding matrix; and if the transmission rank is 8, and both 4TX precoding matrices are 4TX rank 4 precoding matrices.

In some embodiment, the two 4TX precoding matrices may be used to construct a 8TX precoder.

In some embodiment, the control message is a DCI format 0_1 or 0_2 that schedule dynamically scheduled PUSCH or type 2 configured grant PUSCH. Alternatively, the control message is a RRC message that schedules type 1 configured grant PUSCH.

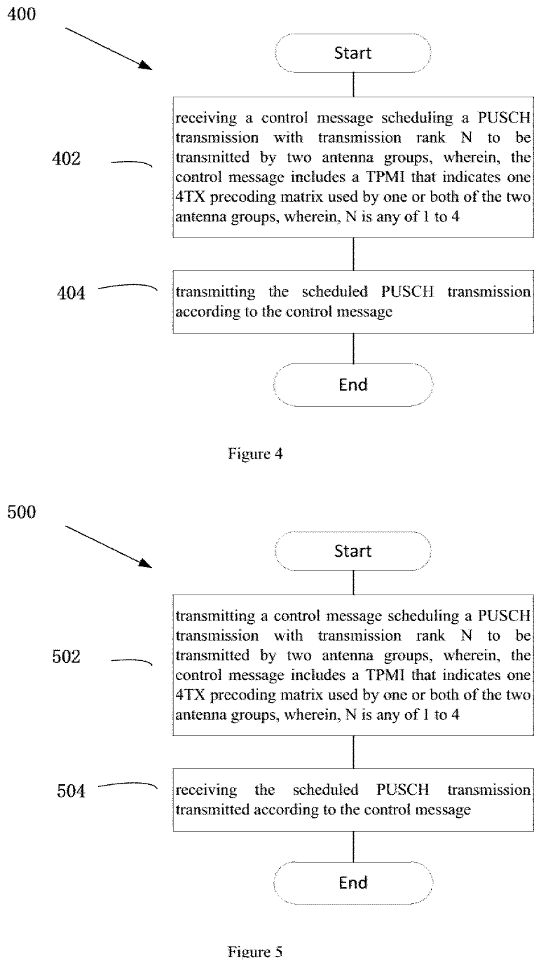

FIG. 4 is a schematic flow chart diagram illustrating an embodiment of a method 400 according to the present application. In some embodiments, the method 400 is performed by an apparatus, such as a remote unit (e.g., UE). In certain embodiments, the method 400 may be performed by a processor executing program code, for example, a microcontroller, a microprocessor, a CPU, a GPU, an auxiliary processing unit, a FPGA, or the like.

The method 400 is a method performed at a UE, comprising: 402 receiving a control message scheduling a PUSCH transmission with transmission rank N to be transmitted by two antenna groups, wherein, the control message includes a TPMI that indicates one 4TX precoding matrix used by one or both of the two antenna groups, wherein, N is any of 1 to 4; and 404 transmitting the scheduled PUSCH transmission according to the control message.

In some embodiment, one of the two antenna groups is indicated by the TPMI to transmit all data streams using the one 4TX precoding matrix.

In some embodiment, the two antenna groups are indicated by the TPMI to transmit the same set of data streams. In particular, both antenna groups use the one 4TX precoding matrix.

In some embodiment, if the transmission rank is 1, the one 4TX precoding matrix is 4TX rank 1 precoding matrix; if the transmission rank is 2, the one 4TX precoding matrix is 4TX rank 2 precoding matrix; if the transmission rank is 3, the one 4TX precoding matrix is 4TX rank 3 precoding matrix; and if the transmission rank is 4, the one 4TX precoding matrix is 4TX rank 4 precoding matrix.

In some embodiment, the control message is a DCI format 0_1 or 0_2 that schedule dynamically scheduled PUSCH or type 2 configured grant PUSCH. Alternatively, the control message is a RRC message that schedules type 1 configured grant PUSCH.

In some embodiment, the one 4TX precoding matrix is selected from a first subset of 4TX precoding matrices of the corresponding rank. In particular, the first subset of 4TX precoding matrices contains 4TX precoding matrices with all antenna ports active. Further, the first subset of 4TX precoding matrices contains a part of 4TX precoding matrices with all antenna ports active.

FIG. 5 is a schematic flow chart diagram illustrating an embodiment of a method 500 according to the present application. In some embodiments, the method 500 is performed by an apparatus, such as a base unit. In certain embodiments, the method 500 may be performed by a processor executing program code, for example, a microcontroller, a microprocessor, a CPU, a GPU, an auxiliary processing unit, a FPGA, or the like.

The method 500 may comprise 502 transmitting a control message scheduling a PUSCH transmission with transmission rank N to be transmitted by two antenna groups, wherein, the control message includes a TPMI that indicates one 4TX precoding matrix used by one or both of the two antenna groups, wherein, N is any of 1 to 4; and 504 receiving the scheduled PUSCH transmission transmitted according to the control message.

In some embodiment, one of the two antenna groups is indicated by the TPMI to transmit all data streams using the one 4TX precoding matrix.

In some embodiment, the two antenna groups are indicated by the TPMI to transmit the same set of data streams. In particular, both antenna groups use the one 4TX precoding matrix.

In some embodiment, if the transmission rank is 1, the one 4TX precoding matrix is 4TX rank 1 precoding matrix; if the transmission rank is 2, the one 4TX precoding matrix is 4TX rank 2 precoding matrix; if the transmission rank is 3, the one 4TX precoding matrix is 4TX rank 3 precoding matrix; and if the transmission rank is 4, the one 4TX precoding matrix is 4TX rank 4 precoding matrix.

In some embodiment, the control message is a DCI format 0_1 or 0_2 that schedule dynamically scheduled PUSCH or type 2 configured grant PUSCH. Alternatively, the control message is a RRC message that schedules type 1 configured grant PUSCH.

In some embodiment, the one 4TX precoding matrix is selected from a first subset of 4TX precoding matrices of the corresponding rank. In particular, the first subset of 4TX precoding matrices contains 4TX precoding matrices with all antenna ports active. Further, the first subset of 4TX precoding matrices contains a part of 4TX precoding matrices with all antenna ports active.

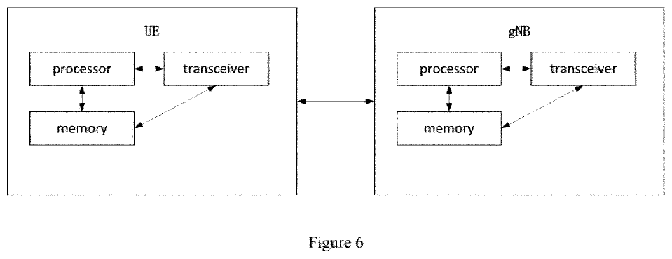

FIG. 6 is a schematic block diagram illustrating apparatuses according to one embodiment.

Referring to FIG. 6, the UE (i.e., the remote unit) includes a processor, a memory, and a transceiver. The processor implements a function, a process, and/or a method which are proposed in FIG. 2 or FIG. 4.

A first UE comprises a transceiver; and a processor coupled to the transceiver, wherein the processor is configured to receive, via the transceiver, a control message scheduling a PUSCH transmission with transmission rank N to be transmitted by two antenna groups, wherein, the control message includes a TPMI that indicates two 4TX precoding matrices used by the two antenna groups, and the two 4TX precoding matrices are of the same type, wherein, N is any of 2 to 8; and transmit, via the transceiver, the scheduled PUSCH transmission according to the control message.

In some embodiment, the precoding matrices are classified into different types according to the number of active transmitting antenna ports and their relative phases.

In some embodiment, the TPMI indicates the two 4TX precoding matrices jointly from possible combinations of two precoding matrices.

In some embodiment, the TPMI includes a first part indicating a first precoding matrix from all possible precoding matrices of a predetermined rank and a second part indicating a second precoding matrix from a subset of possible precoding matrices determined by the first precoding matrix.

In some embodiment, if the transmission rank is 2, both 4TX precoding matrices are 4TX rank 1 precoding matrices; if the transmission rank is 3, the two 4TX precoding matrices are one 4TX rank 1 precoding matrix and one 4TX rank 2 precoding matrix; if the transmission rank is 4, both 4TX precoding matrices are 4TX rank 2 precoding matrices; if the transmission rank is 5, the two 4TX precoding matrices are one 4TX rank 2 precoding matrix and one 4TX rank 3 precoding matrix; if the transmission rank is 6, both 4TX precoding matrices are 4TX rank 3 precoding matrices; if the transmission rank is 7, the two 4TX precoding matrices are one 4TX rank 3 precoding matrix and one 4TX rank 4 precoding matrix; and if the transmission rank is 8, and both 4TX precoding matrices are 4TX rank 4 precoding matrices.

In some embodiment, the processor is further configured to construct a 8TX precoder from the two 4TX precoding matrices.

In some embodiment, the control message is a DCI format 0_1 or 0_2 that schedule dynamically scheduled PUSCH or type 2 configured grant PUSCH. Alternatively, the control message is a RRC message that schedules type 1 configured grant PUSCH.

A second UE comprises a transceiver; and a processor coupled to the transceiver, wherein the processor is configured to receive a control message scheduling a PUSCH transmission with transmission rank N to be transmitted by two antenna groups, wherein, the control message includes a TPMI that indicates one 4TX precoding matrix used by one or both of the two antenna groups, wherein, N is any of 1 to 4; and transmit the scheduled PUSCH transmission according to the control message.

In some embodiment, one of the two antenna groups is indicated by the TPMI to transmit all data streams using the one 4TX precoding matrix.

In some embodiment, the two antenna groups are indicated by the TPMI to transmit the same set of data streams. In particular, both antenna groups use the one 4TX precoding matrix.

In some embodiment, if the transmission rank is 1, the one 4TX precoding matrix is 4TX rank 1 precoding matrix; if the transmission rank is 2, the one 4TX precoding matrix is 4TX rank 2 precoding matrix; if the transmission rank is 3, the one 4TX precoding matrix is 4TX rank 3 precoding matrix; and if the transmission rank is 4, the one 4TX precoding matrix is 4TX rank 4 precoding matrix.

In some embodiment, the control message is a DCI format 0_1 or 0_2 that schedule dynamically scheduled PUSCH or type 2 configured grant PUSCH. Alternatively, the control message is a RRC message that schedules type 1 configured grant PUSCH.

In some embodiment, the one 4TX precoding matrix is selected from a first subset of 4TX precoding matrices of the corresponding rank. In particular, the first subset of 4TX precoding matrices contains 4TX precoding matrices with all antenna ports active. Further, the first subset of 4TX precoding matrices contains a part of 4TX precoding matrices with all antenna ports active.

The gNB (i.e., the base unit) includes a processor, a memory, and a transceiver. The processor implements a function, a process, and/or a method which are proposed in FIG. 3 or FIG. 5.

A first base unit comprises a transceiver; and a processor coupled to the transceiver, wherein the processor is configured to transmit, via the transceiver, a control message scheduling a PUSCH transmission with transmission rank N to be transmitted by two antenna groups, wherein, the control message includes a TPMI that indicates two 4TX precoding matrices used by the two antenna groups, and the two 4TX precoding matrices are of the same type, wherein, N is any of 2 to 8; and receive, via the transceiver, the scheduled PUSCH transmission transmitted according to the control message.

In some embodiment, the precoding matrices are classified into different types according to the number of active transmitting antenna ports and their relative phases.

In some embodiment, the TPMI indicates the two 4TX precoding matrices jointly from possible combinations of two precoding matrices.

In some embodiment, the TPMI includes a first part indicating a first precoding matrix from all possible precoding matrices of a predetermined rank and a second part indicating a second precoding matrix from a subset of possible precoding matrices determined by the first precoding matrix.

In some embodiment, if the transmission rank is 2, both 4TX precoding matrices are 4TX rank 1 precoding matrices; if the transmission rank is 3, the two 4TX precoding matrices are one 4TX rank 1 precoding matrix and one 4TX rank 2 precoding matrix; if the transmission rank is 4, both 4TX precoding matrices are 4TX rank 2 precoding matrices; if the transmission rank is 5, the two 4TX precoding matrices are one 4TX rank 2 precoding matrix and one 4TX rank 3 precoding matrix; if the transmission rank is 6, both 4TX precoding matrices are 4TX rank 3 precoding matrices; if the transmission rank is 7, the two 4TX precoding matrices are one 4TX rank 3 precoding matrix and one 4TX rank 4 precoding matrix; and if the transmission rank is 8, and both 4TX precoding matrices are 4TX rank 4 precoding matrices.

In some embodiment, the two 4TX precoding matrices may be used to construct a 8TX precoder.

In some embodiment, the control message is a DCI format 0_1 or 0_2 that schedule dynamically scheduled PUSCH or type 2 configured grant PUSCH. Alternatively, the control message is a RRC message that schedules type 1 configured grant PUSCH.

A second base unit comprises a transceiver; and a processor coupled to the transceiver, wherein the processor is configured to transmit a control message scheduling a PUSCH transmission with transmission rank N to be transmitted by two antenna groups, wherein, the control message includes a TPMI that indicates one 4TX precoding matrix used by one or both of the two antenna groups, wherein, N is any of 1 to 4; and receive the scheduled PUSCH transmission transmitted according to the control message.

In some embodiment, one of the two antenna groups is indicated by the TPMI to transmit all data streams using the one 4TX precoding matrix.

In some embodiment, the two antenna groups are indicated by the TPMI to transmit the same set of data streams. In particular, both antenna groups use the one 4TX precoding matrix.

In some embodiment, if the transmission rank is 1, the one 4TX precoding matrix is 4TX rank 1 precoding matrix; if the transmission rank is 2, the one 4TX precoding matrix is 4TX rank 2 precoding matrix; if the transmission rank is 3, the one 4TX precoding matrix is 4TX rank 3 precoding matrix; and if the transmission rank is 4, the one 4TX precoding matrix is 4TX rank 4 precoding matrix.

In some embodiment, the control message is a DCI format 0_1 or 0_2 that schedule dynamically scheduled PUSCH or type 2 configured grant PUSCH. Alternatively, the control message is a RRC message that schedules type 1 configured grant PUSCH.

In some embodiment, the one 4TX precoding matrix is selected from a first subset of 4TX precoding matrices of the corresponding rank. In particular, the first subset of 4TX precoding matrices contains 4TX precoding matrices with all antenna ports active. Further, the first subset of 4TX precoding matrices contains a part of 4TX precoding matrices with all antenna ports active.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

1. A user equipment (UE) for wireless communication, comprising:
at least one memory; and
at least one processor coupled with the at least one memory and configured to cause the UE to:
receive a control message scheduling a physical uplink shared channel (PUSCH) transmission with a transmission rank to be transmitted by two antenna groups, wherein the control message includes a transmit precoding matrix indicator (TPMI) that indicates two 4TX precoding matrices used by the two antenna groups, and the two 4TX precoding matrices are a same type; and
transmit the scheduled PUSCH transmission according to the control message.

2. The UE of claim 1, wherein the precoding matrices are classified into different types according to a number of active transmitting antenna ports and their relative phases.

3. The UE of claim 1, wherein the TPMI indicates the two 4TX precoding matrices jointly from possible combinations of two precoding matrices.

4. The UE of claim 1, wherein the TPMI includes a first part indicating a first precoding matrix from all possible precoding matrices of a predetermined rank and a second part indicating a second precoding matrix from a subset of possible precoding matrices determined by the first precoding matrix.

5. The UE of claim 1, wherein:
if the transmission rank is 2, the two 4TX precoding matrices are both 4TX rank 1 precoding matrices;
if the transmission rank is 3, the two 4TX precoding matrices are one 4TX rank 1 precoding matrix and one 4TX rank 2 precoding matrix;
if the transmission rank is 4, the two 4TX precoding matrices are both 4TX rank 2 precoding matrices;
if the transmission rank is 5, the two 4TX precoding matrices are one 4TX rank 2 precoding matrix and one 4TX rank 3 precoding matrix;
if the transmission rank is 6, the two 4TX precoding matrices are both 4TX rank 3 precoding matrices;
if the transmission rank is 7, the two 4TX precoding matrices are one 4TX rank 3 precoding matrix and one 4TX rank 4 precoding matrix; and
if the transmission rank is 8, the two 4TX precoding matrices are both 4TX rank 4 precoding matrices.

6. The UE of claim 1, wherein the at least one processor is configured to cause the UE to construct an 8TX precoder from the two 4TX precoding matrices.

7. The UE of claim 1, wherein the control message is a downlink control information (DCI) format 0_1 or DCI format 0_2 that schedule dynamically scheduled PUSCH or type 2 configured grant PUSCH.

8. The UE of claim 1, wherein the control message is a radio resource control (RRC) message that schedules type 1 configured grant PUSCH.

9. A method performed by a user equipment (UE), the method comprising:
receiving a control message scheduling a physical uplink shared channel (PUSCH) transmission with a transmission rank to be transmitted by two antenna groups, wherein the control message includes a transmit precoding matrix indicator (TPMI) that indicates two 4TX precoding matrices used by the two antenna groups, and the two 4TX precoding matrices are a same type; and
transmitting the scheduled PUSCH transmission according to the control message.

10. A base unit, comprising:
at least one memory; and
at least one processor coupled with the at least one memory and configured to cause the base unit to:
transmit a control message scheduling a physical uplink shared channel (PUSCH) transmission with a transmission rank to be transmitted by two antenna groups, wherein the control message includes a transmit precoding matrix indicator (TPMI) that indicates two 4TX precoding matrices used by the two antenna groups, and the two 4TX precoding matrices are a same type; and
receive the scheduled PUSCH transmission transmitted according to the control message.

11. The base unit of claim 10, wherein the precoding matrices are classified into different types according to a number of active transmitting antenna ports and their relative phases.

12. The base unit of claim 10, wherein the TPMI indicates the two 4TX precoding matrices jointly from possible combinations of two precoding matrices.

13. The base unit of claim 10, wherein the TPMI includes a first part indicating a first precoding matrix from all possible precoding matrices of a predetermined rank and a second part indicating a second precoding matrix from a subset of possible precoding matrices determined by the first precoding matrix.

14. The base unit of claim 10, wherein:
if the transmission rank is 2, the two 4TX precoding matrices are both 4TX rank 1 precoding matrices;
if the transmission rank is 3, the two 4TX precoding matrices are one 4TX rank 1 precoding matrix and one 4TX rank 2 precoding matrix;
if the transmission rank is 4, the two 4TX precoding matrices are both 4TX rank 2 precoding matrices;
if the transmission rank is 5, the two 4TX precoding matrices are one 4TX rank 2 precoding matrix and one 4TX rank 3 precoding matrix;
if the transmission rank is 6, the two 4TX precoding matrices are both 4TX rank 3 precoding matrices;
if the transmission rank is 7, the two 4TX precoding matrices are one 4TX rank 3 precoding matrix and one 4TX rank 4 precoding matrix; and
if the transmission rank is 8, the two 4TX precoding matrices are both 4TX rank 4 precoding matrices.

15. The base unit of claim 10, wherein the two 4TX precoding matrices are used to construct an 8TX precoder.

16. A method performed by a base unit, the method comprising:
transmitting a control message scheduling a physical uplink shared channel (PUSCH) transmission with a transmission rank to be transmitted by two antenna groups, wherein the control message includes a transmit precoding matrix indicator (TPMI) that indicates two 4TX precoding matrices used by the two antenna groups, and the two 4TX precoding matrices are a same type; and
receiving the scheduled PUSCH transmission transmitted according to the control message.

17. The method of claim 9, wherein the precoding matrices are classified into different types according to a number of active transmitting antenna ports and their relative phases.

18. The method of claim 9, wherein the TPMI indicates the two 4TX precoding matrices jointly from possible combinations of two precoding matrices.

19. The method of claim 9, wherein the TPMI includes a first part indicating a first precoding matrix from all possible precoding matrices of a predetermined rank and a second part indicating a second precoding matrix from a subset of possible precoding matrices determined by the first precoding matrix.

20. The method of claim 9, wherein:
if the transmission rank is 2, the two 4TX precoding matrices are both 4TX rank 1 precoding matrices;
if the transmission rank is 3, the two 4TX precoding matrices are one 4TX rank 1 precoding matrix and one 4TX rank 2 precoding matrix;
if the transmission rank is 4, the two 4TX precoding matrices are both 4TX rank 2 precoding matrices;
if the transmission rank is 5, the two 4TX precoding matrices are one 4TX rank 2 precoding matrix and one 4TX rank 3 precoding matrix;
if the transmission rank is 6, the two 4TX precoding matrices are both 4TX rank 3 precoding matrices;
if the transmission rank is 7, the two 4TX precoding matrices are one 4TX rank 3 precoding matrix and one 4TX rank 4 precoding matrix; and
if the transmission rank is 8, the two 4TX precoding matrices are both 4TX rank 4 precoding matrices.
